(19) United States
(12) Patent Application Publication
(10) Pub. No.: US 2006/0044585 A1
(43) Pub. Date: Mar. 2, 2006

(54) Management system, management apparatus, and its control method

(75) Inventor: Takayuki Kaneko, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/212,703

(22) Filed: Aug. 29, 2005

(30) Foreign Application Priority Data
Aug. 30, 2004 (JP) 2004-250933

(51) Int. Cl. G06F 3/12

(52) U.S. Cl. 358/1.13

(57) ABSTRACT

A management PC (107) determines a combination of a printer, which has an idle time band included in that of an operator, of the printers which have idle time periods longer than a time period required to print, in desired quantities, a document received from an apparatus at a client site (161), and this operator, and notifies an operator PC (108) of that combination.

### FIELD OF THE INVENTION

The present invention relates to a technique for managing a work schedule required to generate a print product on the basis of a document.

### BACKGROUND OF THE INVENTION

Conventionally, a service generally called “copy service”, “print service”, or the like, which prints a designated number of copies of a designated document upon reception of a request from a customer, binds printouts by a designated method, and delivers a print product, exists.

A print request is issued by mailing, to a service provider that provides the aforementioned service, a document described on a paper medium or stored in a digital medium (FD, MO, CD-ROM, or the like) and a print order sheet that describes the number of print copies, bookbinding method, due date, and the like of this document (new document entry). Alternatively, in another document entry mode, a service provider provides a document entry service on the Internet, and a customer enters a digital document using, e.g., a browser or the like.

Also, in still another mode, when the customer wants to issue a print request of a document, another print request of which was placed previously, he or she designates the document held in the service provider by phone or the like, and also the number of print copies and the like (repeat document entry).

On the service provider side, the processing order and timings of requests received from many specified or unspecified customers are determined solely by intuition or experience of a person in charge in consideration of the numbers of pages to be printed, due dates, limitations on human and physical resources, and the like (work assignment). According to such schedule, a designated document is copied using a copy machine (in case of a paper document) or is printed by a printer connected to a personal computer (in case of digital document entry), and the print product is finally confirmed and collated, thus delivering it to the customer.

The above work assignment is not always efficient. Especially, the man hour of a person in charge spent for scheduling or the like when a trouble has occurred in the middle of the work often poses a problem. In order to solve this problem, a flow management apparatus that automatically judges and determines assignment of persons in charge and a work schedule is prevalent.

Conventionally, a given flow management apparatus of this type comprises, for example, a function of automatically assigning operators in charge who process unit jobs on the basis of the due dates of unit jobs and the abilities of operators in charge in each execution order of unit jobs (see Japanese Patent Laid-Open No. 8-287162).

Also, another apparatus manages using product lots as units, i.e., has a function of predicting a work period from a reference time (e.g., the production start time) to a product completion step, giving relative merits of a priority order based on overrun values to lots which run over predetermined work periods in respective steps, and performing production management based on such information (Japanese Patent Laid-Open No. 3-221358).

Still another apparatus mainly performs job analysis, i.e., has a function of changing, when the difference between the number of planned jobs (the number of production plans) and the number of job results (the number of production results) exceeds a predetermined value, the work start time of each product in a step before the step which suffers the plan difference, and controlling so that the number of planned jobs can be approached (see Japanese Patent Laid-Open No. 1-183348).

Furthermore, yet another flow management apparatus has a function of allowing to intuitively recognize the schedule states of the entire print system, and changing the processing dates and processes themselves of individual print jobs by intuitive operations (see Japanese Patent Laid-Open No. 2002-63004).

However, none of the aforementioned conventional flow management apparatuses can perform appropriate schedule management by comprehensively judging the abilities and unoccupied states of operators in charge, and the capacities and unoccupied states of devices. For this reason, the following problems are posed: even though work assignment has been done in consideration of the abilities of the operators in charge, no device that can be used in practice is available; or even though work assignment has been done in consideration of the unoccupied states of devices, an operator in charge has no ability to do that work in practice.

### SUMMARY OF THE INVENTION

The present invention has been made in consideration of the aforementioned problems, and has as its object to provide a technique for performing appropriate schedule management.

In order to achieve an object of the present invention, for example, a management system of the present invention comprises the following arrangement.

That is, a management system for managing a schedule for one or more printing apparatuses for generating a print product on the basis of a document received from a client terminal, comprising:

first holding means for holding use time band information required to manage use time bands of the one or more printing apparatuses;

second holding means for holding work time band information required to manage work time bands of a plurality of operators who perform works to generate the print product;

printing apparatus specifying means for specifying printing apparatuses each having an idle time period, in which a time period required to assign a print work of the document in a desired quantity can be assured, of the one or more printing apparatuses on the basis of an idle time band of each of the one or more printing apparatuses obtained with reference to the use time band information;

determination means for determining a combination of an operator and a printing apparatus, having an idle time band included in an idle time band of the operator, of the printing apparatuses specified by the printing apparatus specifying means on the basis of the idle time band of each of the plurality of operators obtained with reference to the work time band information; and

notifying means for notifying information associated with the combination determined by the determination means.

In order to achieve an object of the present invention, for example, a management apparatus of the present invention comprises the following arrangement.

That is, a management apparatus for managing a schedule required to generate a print product on the basis of a document received from a client terminal, comprising:

first holding means for holding use time band information required to manage use time bands of the one or more printing apparatuses;

second holding means for holding work time band information required to manage work time bands of a plurality of operators who perform works to generate the print product;

printing apparatus specifying means for specifying printing apparatuses each having an idle time period, in which a time period required to assign a print work of the document in a desired quantity can be assured, of the one or more printing apparatuses on the basis of an idle time band of each of the one or more printing apparatuses obtained with reference to the use time band information;

determination means for determining a combination of an operator and a printing apparatus, having an idle time band included in an idle time band of the operator, of the printing apparatuses specified by the printing apparatus specifying means on the basis of the idle time band of each of the plurality of operators obtained with reference to the work time band information; and

notifying means for notifying information associated with the combination determined by the determination means.

In order to achieve an object of the present invention, for example, a method of controlling a management apparatus of the present invention comprises the following arrangement.

That is, a method of controlling a management apparatus for managing a schedule required to generate a print product on the basis of a document received from a client terminal, comprising:

a first holding step of holding use time band information required to manage use time bands of the one or more printing apparatuses;

a second holding step of holding work time band information required to manage work time bands of a plurality of operators who perform works to generate the print product;

a printing apparatus specifying step of specifying printing apparatuses each having an idle time period, in which a time period required to assign a print work of the document in a desired quantity can be assured, of the one or more printing apparatuses on the basis of an idle time band of each of the one or more printing apparatuses obtained with reference to the use time band information;

a determination step of determining a combination of an operator and a printing apparatus, having an idle time band included in an idle time band of the operator, of the printing apparatuses specified in the printing apparatus specifying step on the basis of the idle time band of each of the plurality of operators obtained with reference to the work time band information; and

notifying step of notifying information associated with the combination determined in the determination step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing the arrangement of a system according to the first embodiment of the present invention;

FIG. 2 is a block diagram showing the basic arrangement of a client PC, print server 104, database 105, management PC 107, and operator PC 108;

FIG. 3 is a block diagram showing the basic arrangement of a printer;

FIG. 4 is a chart showing the general processing flow of document entry, order reception, order management, and schedule management;

FIG. 5 shows a display example of a login dialog;

FIG. 6 shows a display example of a home page that prompts the user of the client PC to select a desired one of a plurality of services provided by the print server 104;

FIG. 7 shows a display example of a home page used to determine a document to be transmitted from the client PC to the print server 104;

FIG. 8 shows a display example of a file selection dialog;

FIG. 9 shows a display example of a home page that notifies the user that data is being transmitted from the client PC to the print server 104;

FIG. 10 shows a display example of a home page that prompts the user of the client PC to set the print style of the document transmitted in advance;

FIG. 11 shows a display example of a setting dialog used to designate a basic print style;

FIG. 12 shows a display example of a setting dialog used to designate various process settings;

FIG. 13 shows a display example of a home page that prompts the user of the client PC to set a delivery destination of a print product generated based on the document transmitted in advance;

FIG. 14 is a flowchart of the processing implemented when a program, which is held by an auxiliary storage device 203 of the print server 104 to be used in communications with an order manager 402, is loaded onto a RAM 202 of the print server 104, and is executed by a CPU 201 of the print server 104;

FIG. 15 is a table showing an example of the configuration of user information;

FIG. 16 is a table showing an example of setting values to be set in a job ticket;

FIGS. 17A and 17B are tables showing an example of setting values to be set in a job ticket;

FIG. 18 is a table showing an example of setting values to be set in a job ticket;

FIG. 19 is a table showing an example of setting values to be set in a job ticket;

FIG. 20 shows an example of the configuration of a job ticket to be generated in S405;

FIG. 21 is a flowchart of the processing implemented when a CPU 201 of the management PC 107 executes a program of the order manager 402;

FIG. 22 shows a display example of a GUI of the order manager 402;

FIG. 23 is a flowchart of the processing implemented when the CPU 201 of the management PC 107 executes a scheduler server 403;

FIG. 24 is a flowchart of the processing implemented when a CPU 201 of the operator PC 108 executes a scheduler client 404;

FIG. 25 shows a display example of a GUI of the scheduler client 404 which is displayed on the display screen of an image display device 204 of the operator PC 108 in step S2405;

FIG. 26 shows an example of the configuration of a table which registers private information including the abilities of respective operators;

FIG. 27 shows an example of the configuration of a table which indicates the meanings of “1” and “0”;

FIG. 28 shows an example of the configuration of a table which indicates the performances of printers and bookbinding apparatuses;

FIG. 29 is a table showing an example of setting values registered in FIG. 28;

FIG. 30 is a flowchart showing details of a generation process of schedule information according to this embodiment, which is executed in step S2306;

FIG. 31 shows an example of the configuration of a table that registers schedule information of operators and devices;

FIG. 32 shows a display example of a GUI that visually shows schedule information registered in the table shown in FIG. 31;

FIG. 33 is a flowchart of the generation process of schedule information according to this embodiment, which is executed in step S2306;

FIG. 34 shows an example of the configuration of a job ticket which is edited when the flow advances from step S3304 to step S3306 via steps S3308 and S3305;

FIG. 35 shows a display example of a GUI displayed on the display screen of the image display device 204 of the operator PC 108 when schedule information 1 is input to the operator PC 108, which is not notified of another schedule information yet at that time;

FIG. 36 shows a display example of a GUI displayed on the display screen of the image display device 204 of the operator PC 108 when schedule information 2 is input to the operator PC 108, and schedule information 1 has been input in advance;

FIG. 37 shows a display example of a GUI displayed on the display screen of the image display device 204 of the operator PC 108 when schedule information 3 is input to the operator PC 108, and schedule information 1 and schedule information 2 have been input in advance; and

FIG. 38 shows a display example of a GUI displayed on the display screen of the image display device 204 of the operator PC 108 when schedule information 4 is input to the operator PC 108, and schedule information 1, schedule information 2, and schedule information 3 have been input in advance.

### DETAILED DESCRIPTION OF THE PREFERRED EMBODIMENTS

Preferred embodiments of the present invention will now be described in detail in accordance with the accompanying drawings.

### First Embodiment

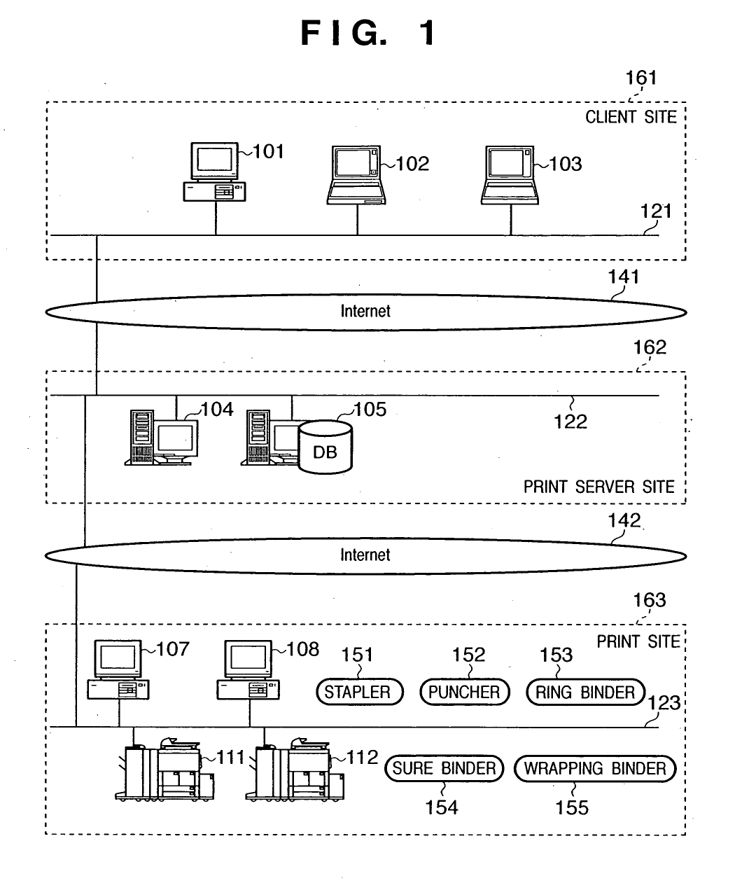

FIG. 1 is a diagram showing an example of the arrangement of a system according to this embodiment. The system according to this embodiment comprises an apparatus group (101, 102, 103) arranged at a client site 161, an apparatus group (104, 105) arranged at a print server site 162, and an apparatus group (107, 108, 111, 112, 151 to 155) arranged at a print site 163. Note that the numbers of apparatuses located at the respective sites are not limited to those in FIG. 1, and some apparatuses may be combined in each site.

The apparatus group at each site can make data communications via a LAN (121, 122, 123), and the respective sites can make data communications via the Internet (141, 142). Note that a network that connects the apparatus group in each site and a network that connects the sites are not limited to those in FIG. 1.

The apparatuses at each site will be explained first. The client site 161 is provided in an environment such as an office, home, and the like. The client site 161 includes a general PC (personal computer) 101, notebook PC 102, and wordprocessor 103. An indispensable function of these apparatuses is a function of establishing connection to the Internet 141 and making data communications via this Internet 141. Hence, the apparatuses arranged at the client site 161 are not limited to those described above as long as they have that function and, for example, a PDA, game apparatus, and the like may be used. The apparatuses arranged at the client site 161 will be generally called as a client PC hereinafter.

The print server site 162 will be described next. The print server site 162 is arranged in an environment that mediates the client site 161 and print site 163, so as to provide services (to be described later) of the print site 163 to the client PC. The print server site 162 includes a print server 104 and database 105. The operations of these apparatuses will be described later.

The print site 163 will be described below. The print site 163 is provided in an environment that provides services (to be described later) to the client PC, i.e., at a print site in an intra-company POD (Page On Demand) system and CRD (Centralized Reprographic Department). This print site 163 is provided with an apparatus group including: a management PC 107 as a schedule management apparatus according to this embodiment, operator PC 108, monochrome MFP (Multi Function Peripheral: a multi-functional copying machine which has a scanner function, print function, FAX function, and the like and can also use a finisher device having a staple/punch function, and the like in many models) 111, and color MFP 112; and a bookbinding apparatus group including: a stapler 151 and puncher 152 as option devices attached to the monochrome MFP 111, color MFP 112, and the like and a ring binder 153, sure binder 154, and wrapping binder 155 used to perform more complicated bookbinding processes. Note that post-press apparatuses for processing prints may be further provided in addition to the bookbinding apparatuses.

The operations of the apparatus at the respective sites will be briefly described below. The client PC (PC 101, notebook PC 102, wordprocessor 103) comprises a known browser which can access the print server 104 via the Internet 141, and is used to browse a home page provided by the print server 104, and can display the home page provided by the print server 104 on the display screen of its display device. The client PC can transmit various data and commands to the print server 104 via this browser.

Hence, when the user of the client PC wants to issue a generation request of a print product based on his or her document, he or she accesses the home page provided by the print server 104 using this browser, and transmits that document to the print server 104 on this home page, and transmits data which designates the print style such as a bookbinding instruction and the like, and data that designates the due date and delivery destination of the print product, to the print server 104. In this manner, this user can place a print/bookbinding order (to be simply referred to as an order or print order hereinafter) based on his or her document.

Note that processes such as a login process to the print server 104, session management of communications, network communications, security management, and the like using arbitrary protocols are executed during a series of processes required to access the home page and place an order. However, since these processes are known techniques, and depart from the gist of this embodiment, a description thereof will be omitted.

The apparatuses 101, 102, and 103 which form the client PC are connected to the LAN 121, and can make data communications with each other. Hence, for example, when the user wants to place the order from the PC 101, he or she may acquire document data to be transmitted to the print server 104 from other apparatuses 102 and 103.

On the other hand, the print server 104 at the print server site 162 performs connection management from the client PC, and executes processes for providing the home page to the client PC, and receiving various data transmitted from the client PC via this home page. It is a common practice to use JSP (Java Server Pages), ASP (Active Server Pages), and the like to provide this home page. The print server 104 makes data communications with the management PC 107 at the print site 163 via the Internet 142.

In general, upon managing such home page, the print server 104 can perform account management, security management, DB cooperation, cooperation with a cooperate-office backbone system, and the like. However, since these processes are known techniques, and depart from the gist of this embodiment, a description thereof will be omitted.

The database 105 holds and manages, e.g., programs and data associated with the aforementioned home page, various data transmitted from the client PC, and a data group to be stored in advance (to be described later).

The print server 104 and database 105 are connected to the LAN 122, and can make data communications with each other.

On the other hand, the management PC 107 at the print site 163 can establish connection to the print server 104 via the Internet 142. The management PC 107 downloads, from the print server 104, document data and various other data transmitted from the client PC to the print server 104, and performs management of entered document data, that of a generation schedule of a print product based on the document, and so forth.

The operator PC 108 is used by the operator who performs an operation for generating a print product based on document data in various use purposes.

As is well known, the monochrome MFP 111 is an MFP that handles monochrome images, and the color MFP 112 is an MFP that handles color images. In the following description, these MFPs will be generally called as a printer in some cases.

A finisher is attached to the printer, and staple and punch finishing functions are available, thus improving the print image quality. Hence, assume that the bookbinding apparatuses such as the stapler 151 and puncher 152 are attached to this printer.

The bookbinding apparatuses 153, 154, and 155 are independent from the printer, and are used to perform ring binding, sure binding, and wrapping binding.

The management PC 107, operator PC 108, monochrome MFP 111, and color MFP 112 are connected to the LAN 122 and can make data communications with each other.

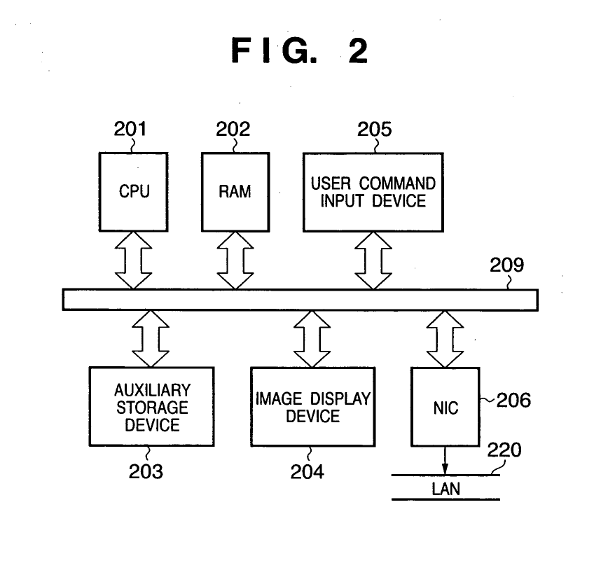

FIG. 2 is a block diagram showing the basic arrangement of the client PC, print server 104, database 105, management PC 107, and operator PC 108. In this embodiment, these apparatuses have the same arrangement as that of a general PC, and have the same basic arrangement. However, the arrangements of the respective apparatuses may be changed as needed. In the following description, the client PC, print server 104, database 105, management PC 107, and operator PC 108 will be simply and generally called a PC.

Reference numeral 201 denotes a CPU which controls the overall PC using programs and data loaded onto a RAM 202, and executes processes to be described later to be executed by the apparatus that uses this PC.

Reference numeral 202 denotes a RAM which has an area for temporarily storing programs and data loaded from an auxiliary storage device 203 and also an area for temporarily storing programs and data which are exchanged via an NIC (network interface card) 206. The RAM 202 also has a work area required when the CPU 201 executes various processes.

Reference numeral 203 denotes an auxiliary storage device which comprises a large-capacity information storage device such as a hard disk drive or the like. The auxiliary storage device saves an OS (operating system), programs and data (including data of tables to be described later) that make the CPU 201 implement processes to be executed by the apparatus that uses this PC, and the like. Some or all of these programs and data are read out onto the RAM 202 under the control of the CPU 201, and are executed by the CPU 201, thus implementing the processes to be executed by the apparatus that uses this PC.

Reference numeral 204 denotes an image display device which comprises a CRT, liquid crystal display, or the like, and can display the processing result of the CPU 201 using images, text, and the like.

Reference numeral 205 denotes a user command input device, which includes a keyboard, mouse, and the like, and can input various instructions to the CPU 201.

Reference numeral 206 denotes an NIC (network interface card) which is used to connect this PC to a LAN 220. This PC can make data communications with apparatuses connected to the LAN 220 and those on the Internet connected to the LAN 220 via this NIC 206.

Reference numeral 209 denotes a main bus which interconnects the aforementioned units.

Reference numeral 220 denotes a LAN which corresponds to the LAN 121, 122, or 123 in FIG. 1.

Note that the arrangement of the PC is not limited to such specific arrangement. In addition, a drive device used to read out programs and data recorded on a storage medium such as a CD-ROM, DVD-ROM, or the like may be connected to the main bus 209.

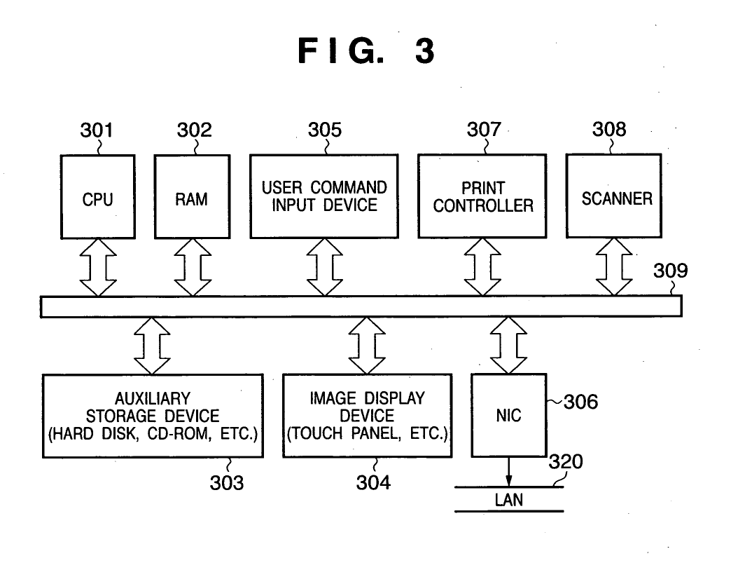

FIG. 3 is a block diagram showing the basic arrangement of the printer.

Reference numeral 301 denotes a CPU which controls the overall printer, and interprets externally received print data and controls known processes to be done by the MFP (e.g., to control a print process and finishing control).

Reference numeral 302 denotes a RAM which comprises a work area of the CPU 301, an area for temporarily storing print data, an area for temporarily storing image data scanned by a scanner 308, and the like.

Reference numeral 303 denotes an auxiliary storage device, which is used to temporarily hold print data, or as a substitute for the RAM 302 based on judgment of the CPU 301.

Reference numeral 304 denotes an image display device such as a touch panel or the like. The image display device 304 displays printer status, error messages, and the like, and can input instructions such as a designation of the number of copies, zoom designation, a print cancel, and the like by designating button images displayed on its display screen.

Reference numeral 305 denotes a user command input device which includes a button group used to input numerical values of the number of copies, zoom magnification, and the like. Note that the user command input device 305 and image display device 304 may be integrated. That is, the button group may be displayed on the touch panel as images, and a corresponding numerical value may be input by designating these button images.

Reference numeral 306 denotes an NIC which is used to connect this printer to a LAN 320. This printer can make data communications with apparatuses connected to the LAN 320 via this NIC 306 and those on the Internet connected to the LAN 320.

Reference numeral 307 denotes a print controller which controls processing for actually outputting externally input print data onto paper sheets. In this embodiment, the print controller 307 also manages finisher control. Reference numeral 308 denotes a scanner which scans an image on a document and inputs monochrome binary (or color) image data.

Reference numeral 309 denotes a main bus which interconnects the aforementioned units.

Reference numeral 320 denotes a LAN which corresponds to the LAN 121, 122, or 123 in FIG. 1.

Note that the arrangement of the printer is not limited to such specific arrangement, and the printer may simply have a print function alone. In such case, the scanner 308 is not required.

In the arrangements of the PC and printer, the NIC is used to connect the LAN. However, the present invention is not limited to this, and a parallel interface, serial interface, USB, or the like may be used.

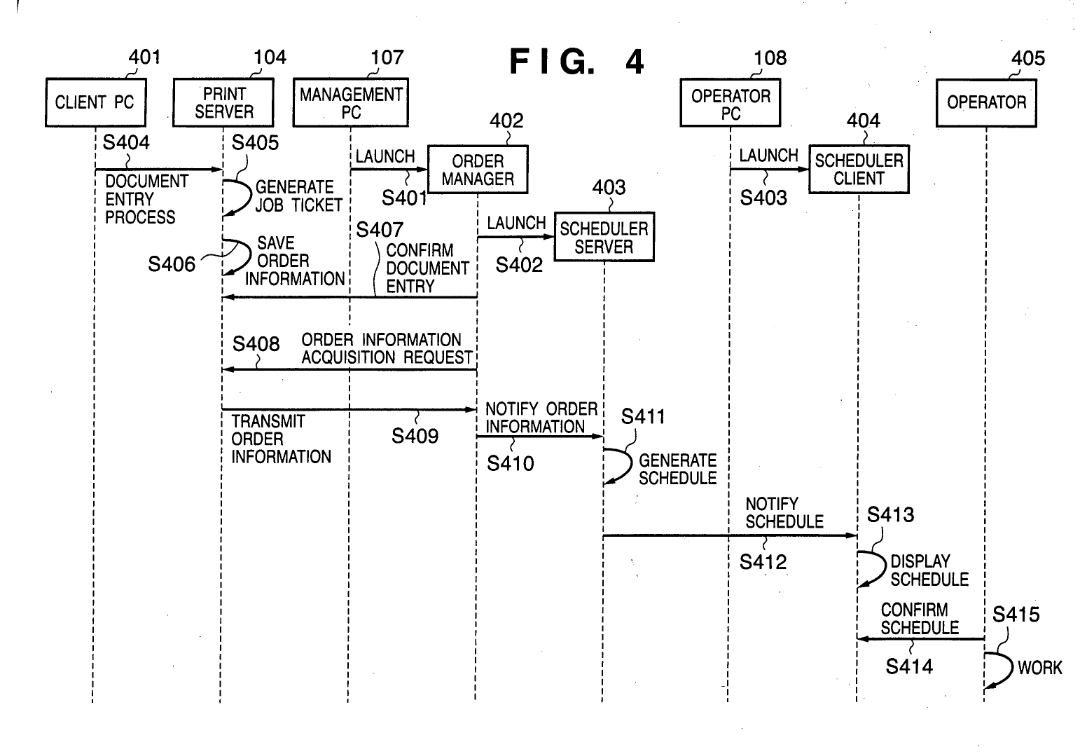

An overview of the general processing flow of document entry, order reception, order management, and schedule management will be described below. FIG. 4 is a chart showing this processing flow.

The management PC 107 launches an order manager 402 as a program, which is loaded from its auxiliary storage device 203 onto the RAM 202 (S401). The order manager 402 launches a scheduler server program (to be referred to as a scheduler server hereinafter) 403 (S402). The operator PC 108 launches a scheduler client program (to be referred to as a scheduler client hereinafter) 404 as a program, which is loaded from its auxiliary storage device 203 onto the RAM 202 (S403).

Upon completion of the above processes, when the user of the client PC transmits (enters) document data and data indicating the print style, delivery destination, due date, and the like to the print server 104 using the client PC (S404), the print server 104 saves the data indicating the print style, delivery destination, due date, and the like in a job ticket (S405), and saves and manages the job ticket in the auxiliary storage device 203 as order information in association with the document data (S406). The job ticket can be referred to and edited at arbitrary timings by a service program that runs on the print server 104, the order manager 402 and scheduler server 403 that run on the management PC 107, and the scheduler client 404 that runs on the operator PC 108, and a series of judgments and processes are done by the CPU 201 of each individual apparatus.

The order manager 402 periodically communicates with the print server 104 to confirm order entry states. Upon detection of an order entry (S407), the order manager 402 requests the print server 104 to acquire order information (information as a pair of document data and a job ticket) (S408). In response to this request, the print server 104 transmits the order information to the order manager 402 (S409). Upon reception of the order information in S409, the order manager 402 notifies the scheduler server 403 of the order information (S410). The scheduler server 403 makes schedule management required to generate a print product on the basis of this order information, and forms an appropriate schedule (S411). Details of the process in S411 will be described later.

After the schedule is fixed, the scheduler server 403 notifies the scheduler client 404 of the schedule (S412). The scheduler client 404 displays the schedule contents on the image display device 204 of the operator PC 108 (S413). An operator 405 confirms the displayed schedule (S414) and performs output operations (print, bookbinding, etc.) (S415).

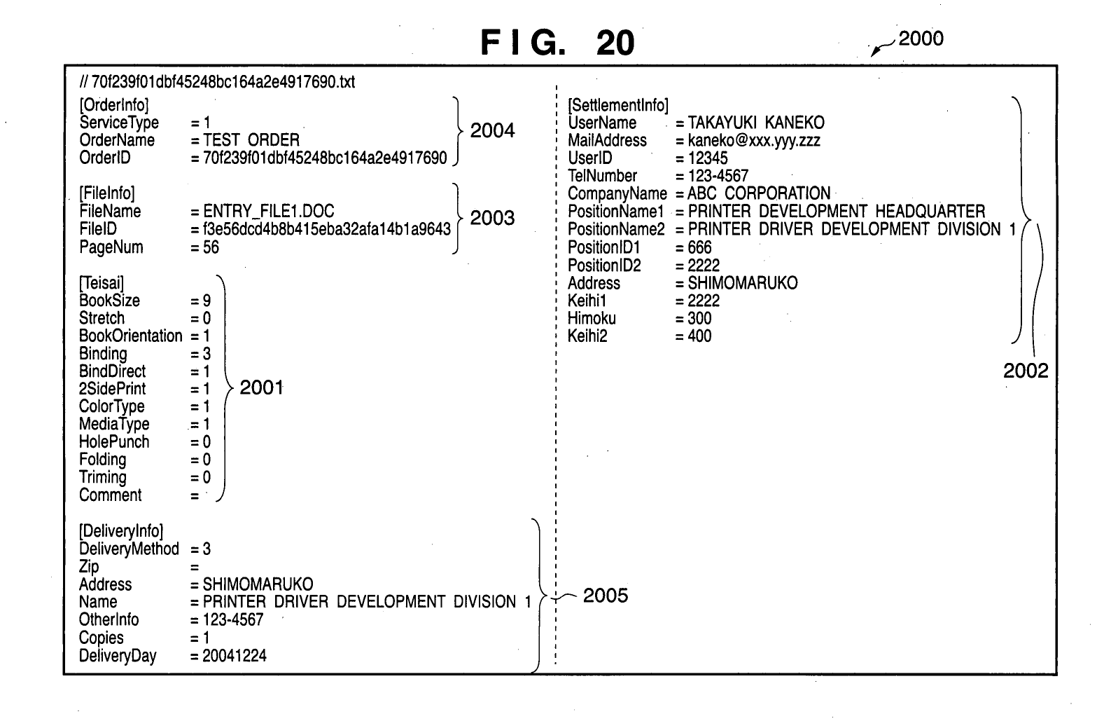

FIG. 20 shows an example of the configuration of the job ticket generated in S405. A job ticket 2000 shown in FIG. 20 records various kinds of information. For example, reference numeral 2001 denotes a section that records information indicating the print style of the document which is transmitted to the print server 104 together with this job ticket 2000; 2002, a section that records information associated with the transmission source of the document; 2003, a section that records information associated with the document included in job information together with this job ticket 2000; 2004, a section that records information associated with a service demanded from the client PC; and 2005, a section that records information associated with the delivery destination of a print product generated based on this document. In this embodiment, the job ticket manages information using sections (major divisions), keys (minor divisions), and setting values in association with respective setting items in a text format. However, the job ticket may have an XML format, JDF format, or the like.

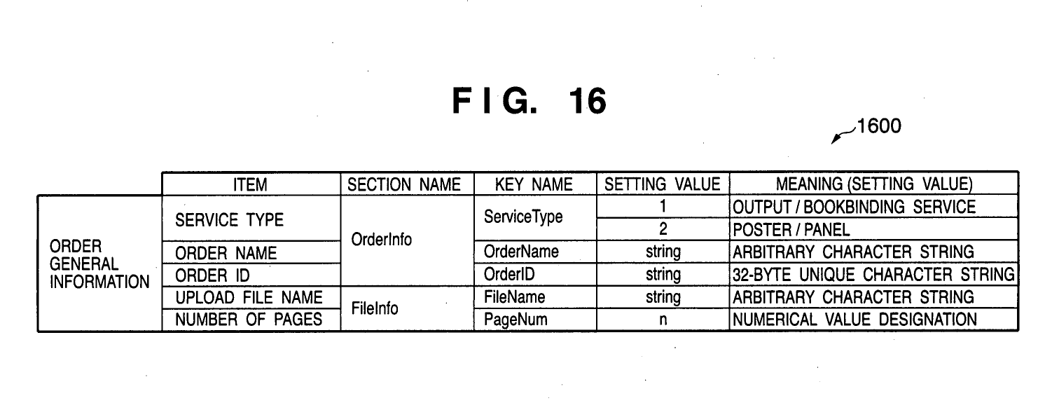

FIGS. 16 to 19 show an example of setting values to be set in the job ticket. The processing contents in S404 associated with document entry and the setting values shown in FIGS. 16 to 19 will be described later.

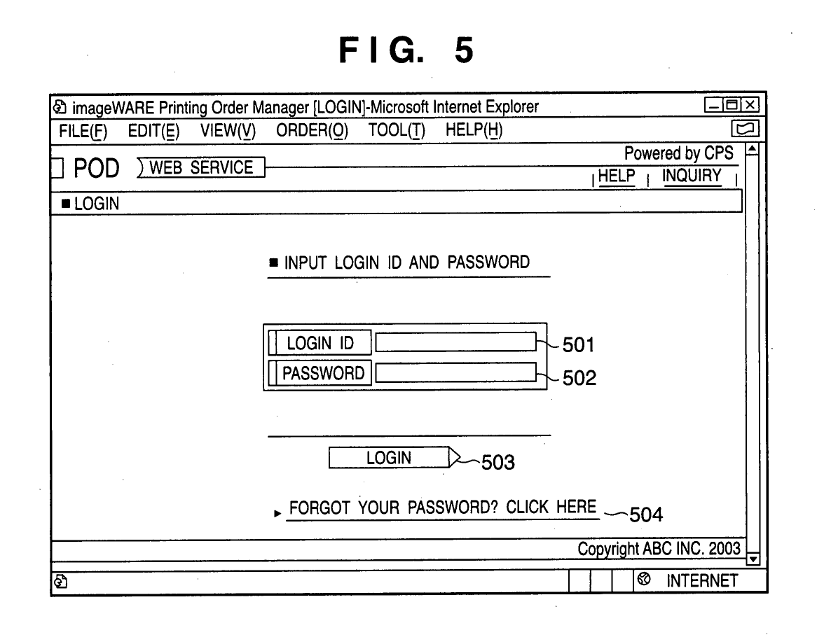

FIGS. 5 to 14 show display examples of the home page provided by the print server 104 upon making document entry in S404 in FIG. 4. Data of this home page is saved in the auxiliary storage device 203 of the print server 104 or that of the database 105, and the print server 104 transmits the data to the client PC as needed. The home page data transmitted to the client PC is interpreted by the CPU 201 of the client PC, which displays dialogs according to the interpretation result on the display screen of the image display device 204 of the client PC.

FIG. 5 shows a display example of a login dialog. Upon accessing the home page provided by the print server 104 from the client PC, the login dialog shown in FIG. 5 is displayed on the display screen of the image display device 204 of the client PC.

The user of the client PC inputs a login ID and password, which have been issued for him or her in advance, in fields 501 and 502. Upon completion of input, the user designates a login button 503 by a known method. As the known method, for example, the user moves a mouse cursor (not shown) to the position of the login button 503 and clicks a mouse button there, thus designating the login button 503.

In the following description, a description of operations upon designating designation parts displayed on the home page and those to dialogs will be omitted, because such operations are attained by the known method.

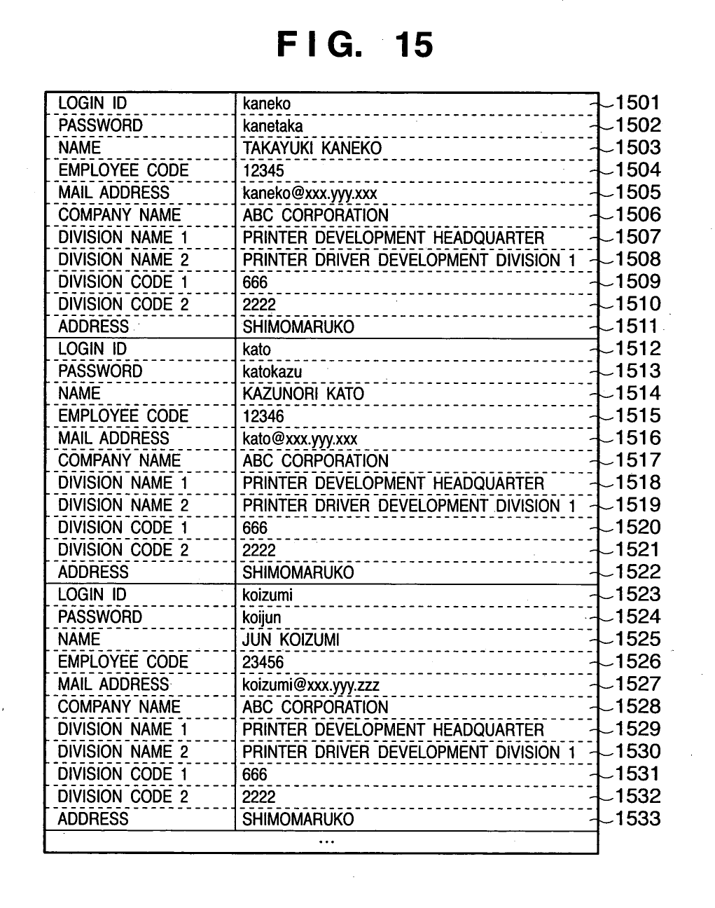

Upon designating the login button 503, the login ID and password input to the fields 501 and 502 are input to the print server 104, and undergo an authentication process. Such authentication process at the time of login is a known technique, and a detailed description thereof will be omitted. For example, when a private information table including login IDs and passwords of respective users shown in FIG. 15 is saved in advance in the auxiliary storage device 203 of the print server 104, the CPU 201 of the print server 104 checks with reference to this table if a combination of the login ID and password transmitted from the client PC matches that registered in this table. If the combination of the login ID and password is registered, the CPU 201 determines that this user is successfully authenticated, and executes the subsequent processes.

FIG. 15 shows an example of the configuration of the user information. In FIG. 15, fields 1501 to 1511 record private information of a user “Takayuki Kaneko”, fields 1512 to 1522 record that of a user “Kazunori Kato”, and fields 1523 to 1533 record that of a user “Jun Koizumi”.

The authentication process can be done in this manner. However, since various methods of the authentication process may be used, the present invention is not limited to the aforementioned method. Also, since the authentication process is not the gist of this embodiment, no more explanation will be avoided. Such private information table may be saved in the auxiliary storage device 203 of the database 105, and the CPU 201 of the print server 104 may refer to it via the LAN 122. Also, user authentication may be implemented by cooperation with an SSL (Single Sign On) server or intra-office backbone system.

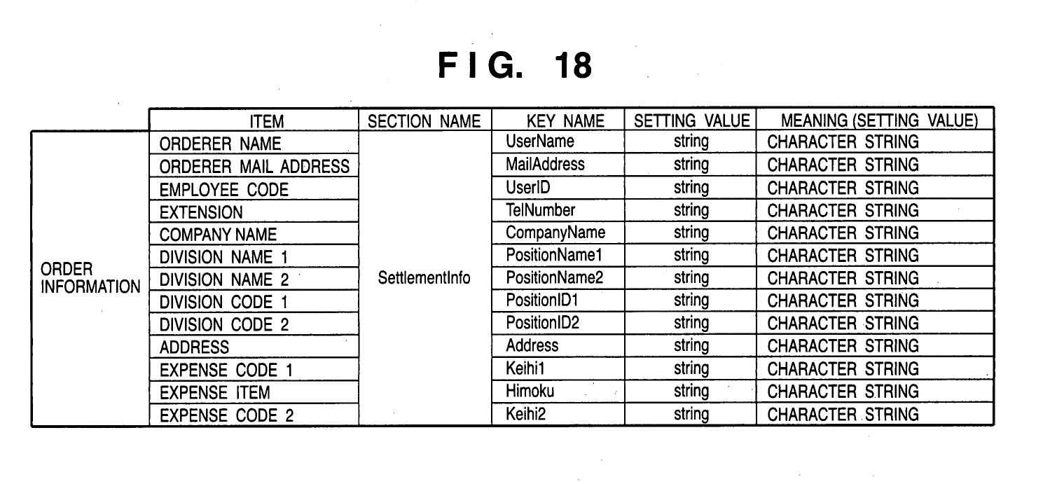

In this manner, the print server 104 executes the authentication process. After that, the CPU 201 of the print server 104 sets the private information of the authenticated user in respective items in the section 2002 (“SettlementInfo” section) in the job ticket 2000. In FIG. 20, since the user “Takayuki Kaneko” is the authenticated user, the private information items 1501 to 1511 of the user “Takayuki Kaneko” of the private information of the respective users shown in FIG. 15 are registered in the section 2002. Upon registration, key names and setting values corresponding to the contents of respective private information are specified with reference to a table shown in FIG. 18 (saved together with the table shown in FIG. 15).

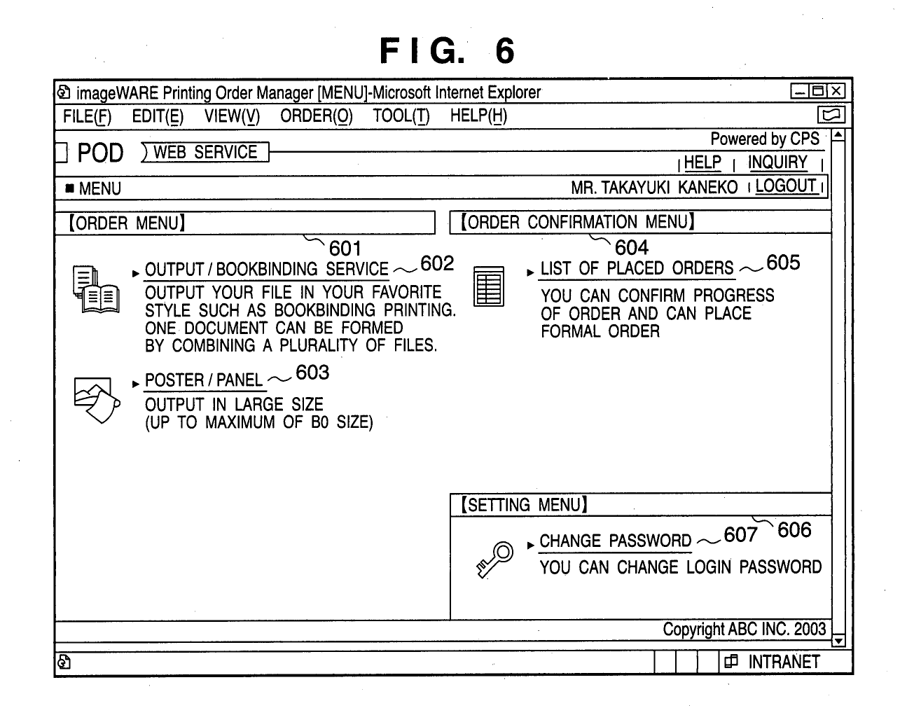

Upon completion of the above process, the print server 104 transmits the next home page data to the client PC. FIG. 6 shows a display example of the home page that prompts the user of the client PC to select a desired one of a plurality of services provided by the print server 104. The display example of FIG. 6 is displayed on the display screen of the image display device 204 of the client PC.

Reference numeral 602 denotes a field which is to be designated to request generation of (output/bookbinding) of a print product based on a document transmitted to the print server 104. Reference numeral 603 denotes a field which is to be designated to request generation of a poster or panel based on a document transmitted to the print server 104.

Reference numeral 605 denotes a field which is to be designated to issue a confirmation request of the already placed order information to the print server 104. Reference numeral 607 denotes a field which is to be designated to change the password which has already been registered. The user can change the password at an arbitrary timing. When the user changes the password, the password (e.g., 1502 in FIG. 15) already registered in the private information of this user is updated to a newly set one. Since such password change process is known, and is not the gist of this embodiment, a description thereof will be omitted.

A case will be explained below wherein the user designates the field 602.

When the user of the client PC designates the field 602, the print server 104 acquires a code “1” indicating that the “output/bookbinding service” is requested from a table shown in FIG. 16 (saved in the auxiliary storage device 203 of the print server 104) in response to this designation, and sets the acquired code in an item “ServiceType” in the section 2004 (“OrderInfo” section) in the job ticket 2000.

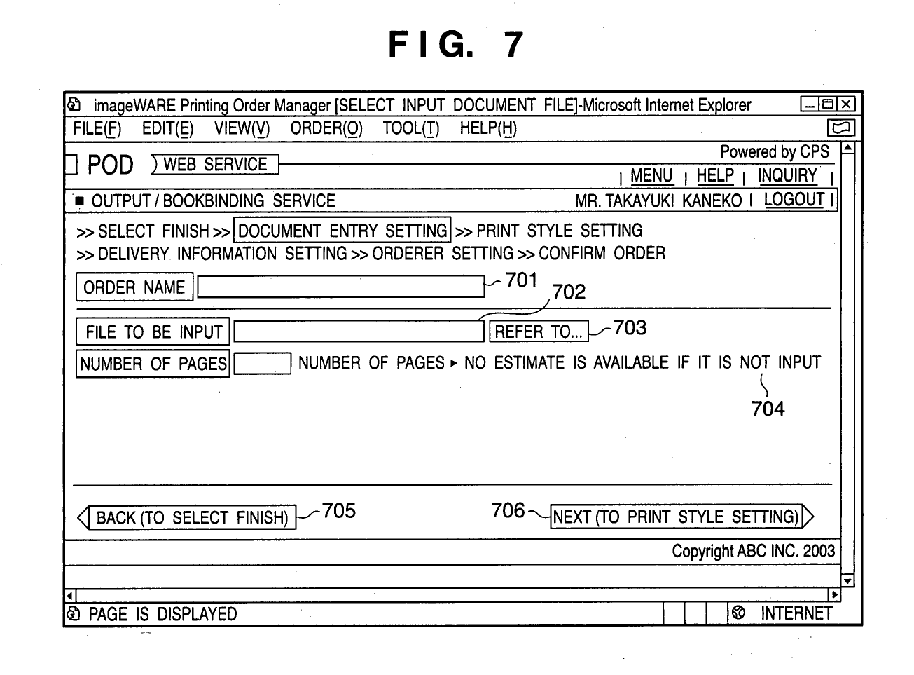

After that, data of a home page shown in FIG. 7 is transmitted to the client PC. FIG. 7 shows a display example of a home page used to determine a document to be transmitted from the client PC to the print server 104.

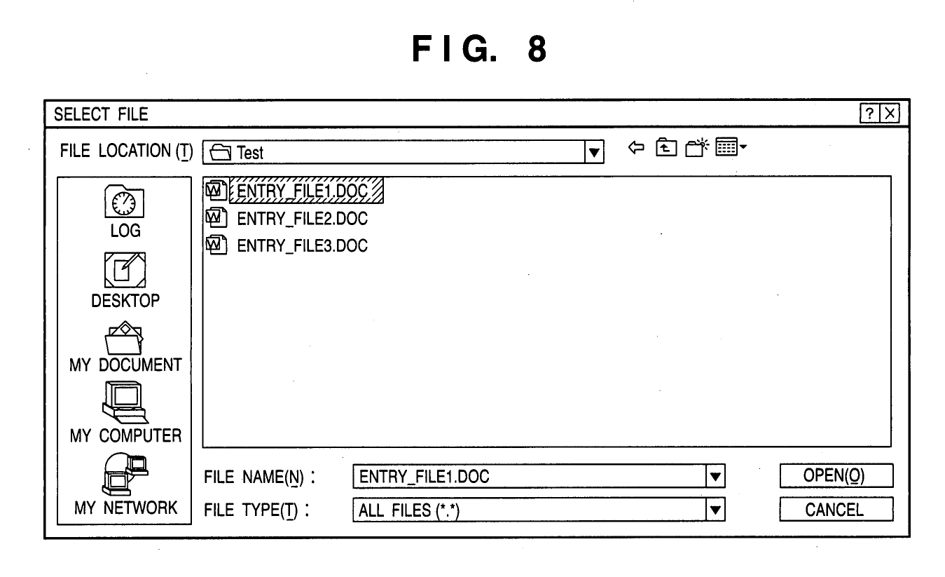

Reference numeral 701 denotes an edit box used to input an order name; 702, an edit box used to input a file name of a document to be transmitted to the print server 104 (including path information indicating the save location of this document); and 704, an edit box used to input the number of pages of the document to be transmitted to the print server 104. Upon depression of a reference button 703, a file selection dialog shown in FIG. 8 is displayed, and the user can select a desired document to be transmitted to the print server 104. One or more files may be selected. FIG. 8 shows a display example of the file selection dialog.

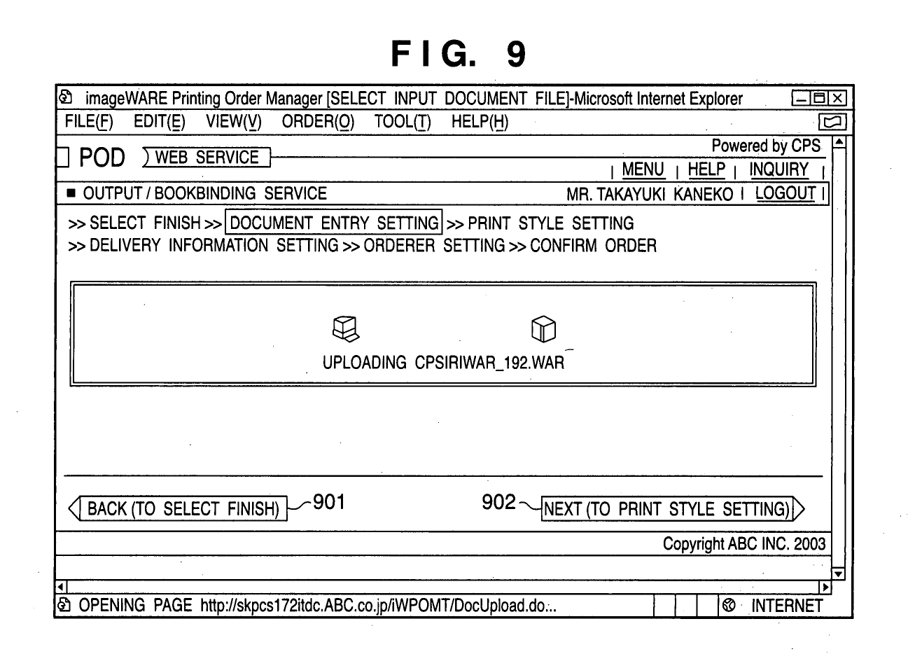

When the user inputs information to be input to the text boxes 701, 702, and 703, and designates a button image 706, the CPU 201 of the client PC reads out the file of the document specified by the path input to the text box 702 from its own auxiliary storage device 203 or that of another apparatus, and transmits the readout file to the print server 104 together with the character string data input to the text boxes 701 and 704. The print server 104 receives the file and data and temporarily stores them in its own RAM 202. Upon reception of the instruction of the button image 706, the CPU 201 of the print server 104 transmits data of a home page shown in FIG. 9 to the client PC. Then, a dialog shown in FIG. 9 is displayed on the display screen of the image display device 204 of the client PC.

FIG. 9 shows a display example of a home page which notifies the user that data is being transmitted from the client PC to the print server 104.

Upon reception of the data transmitted from the client PC, the print server 104 sets the character string input to the text box 701 in “OrderName” in the “OrderInfo” section, the file name input to the text box 702 in “FileName” in a “FileInfo” section, and the number of pages input to the text box 704 in “PageNum” in the “FileInfo” section of the job ticket 2000.

An ID unique to each order, which is issued by the CPU 201 of the print server 104 for each order, is set in “OrderID” in the “OrderInfo” section, and an ID unique to each file, which is issued by the CPU 201 of the print server 104 for each file, is set in “FileID” in the “FileInfo” section. The setting method follows a table shown in FIG. 16 (saved in the auxiliary storage device 203 of the print server 104).

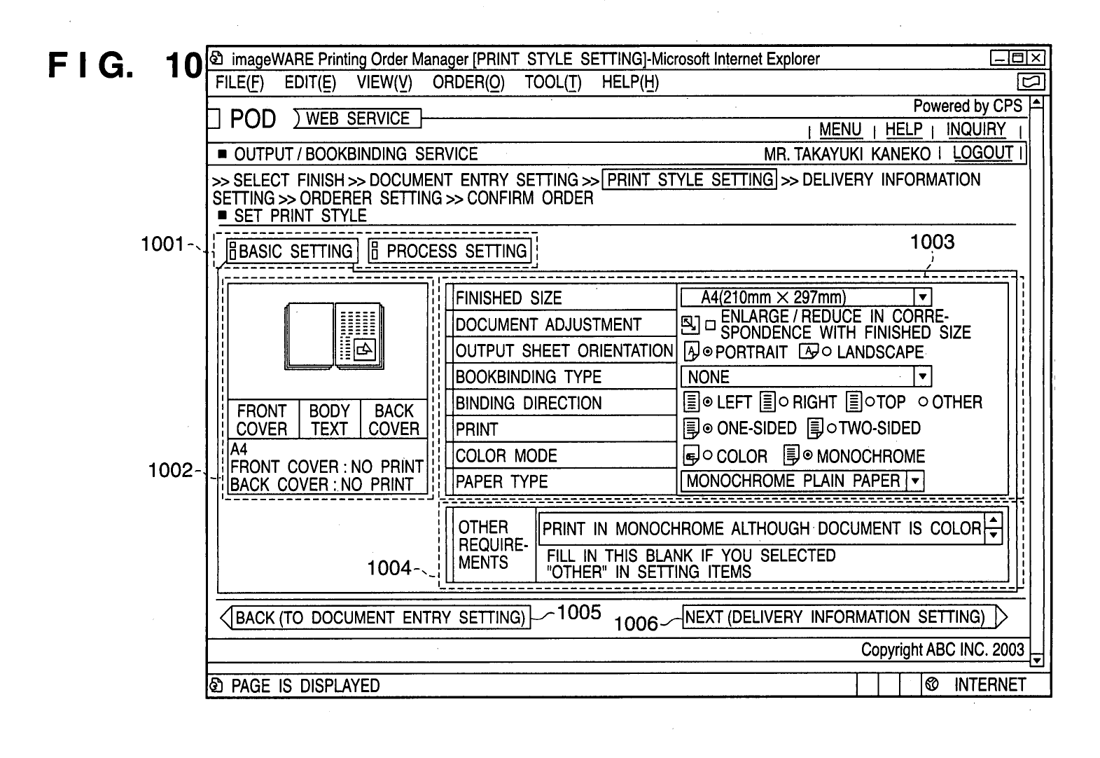

Upon completion of the above processes, the print server 104 transmits data of a home page shown in FIG. 10 to the client PC. Then, the home page shown in, e.g., FIG. 10, is displayed on the display screen of the image display device 204 of the client PC. FIG. 10 shows a display example of the home page that prompts the user of the client PC to set the print style of the document transmitted in advance.

Referring to FIG. 10, reference numeral 1001 denotes a field for displaying a button image used to designate “basic setting” and a button image used to designate “process setting”, and this field allows the user to designate one of these button images.

Reference numeral 1002 denotes a field which displays a so-called preview as a result of simulating a print result when the document transmitted in advance is printed based on the designated print settings.

Reference numeral 1003 denotes a field for inputting print settings (print style) for the document transmitted in advance.

Reference numeral 1004 denotes a field for describing a comment and the like.

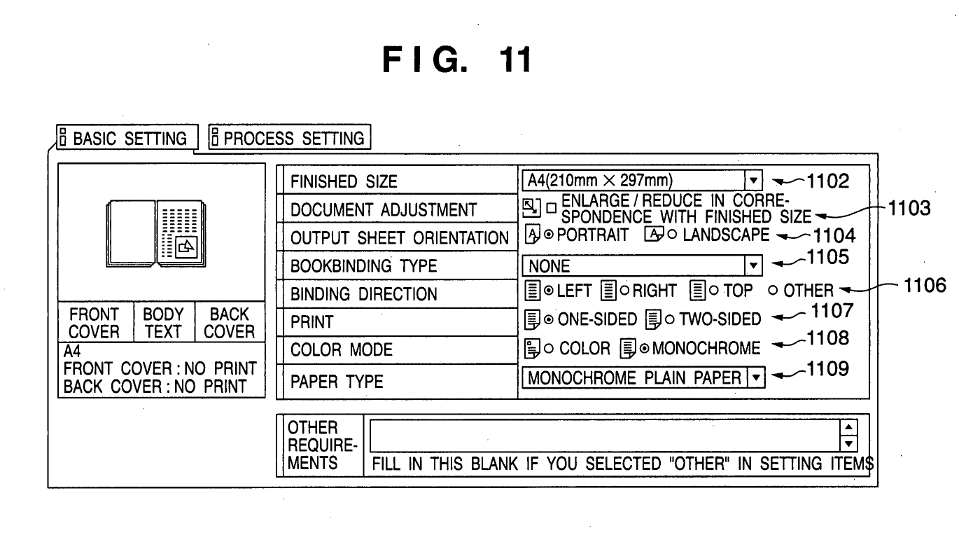

When the user designates the button image “basic setting” in the field 1001, a dialog shown in FIG. 11 is displayed on the field 1003. FIG. 11 shows a display example of a setting dialog used to designate the basic print style. On this setting dialog, a finished size 1102, document adjustment 1103, output sheet orientation 1104, bookbinding type 1005, binding direction 1106, print face designation 1107, color mode 1108, and paper type 1109 can be set.

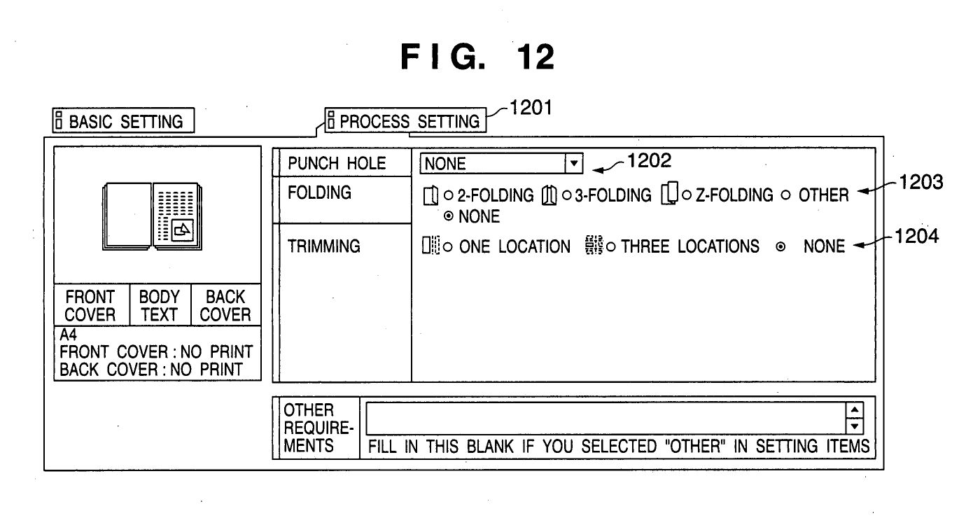

On the other hand, when the user designates the button image “process setting” in the field 1001, a dialog shown in FIG. 12 is displayed on the field 1003. FIG. 12 shows a display example of a setting dialog used to designate various process settings. On the setting dialog shown in FIG. 12, a punch hole 1202, folding 1203, and trimming 1204 can be set.

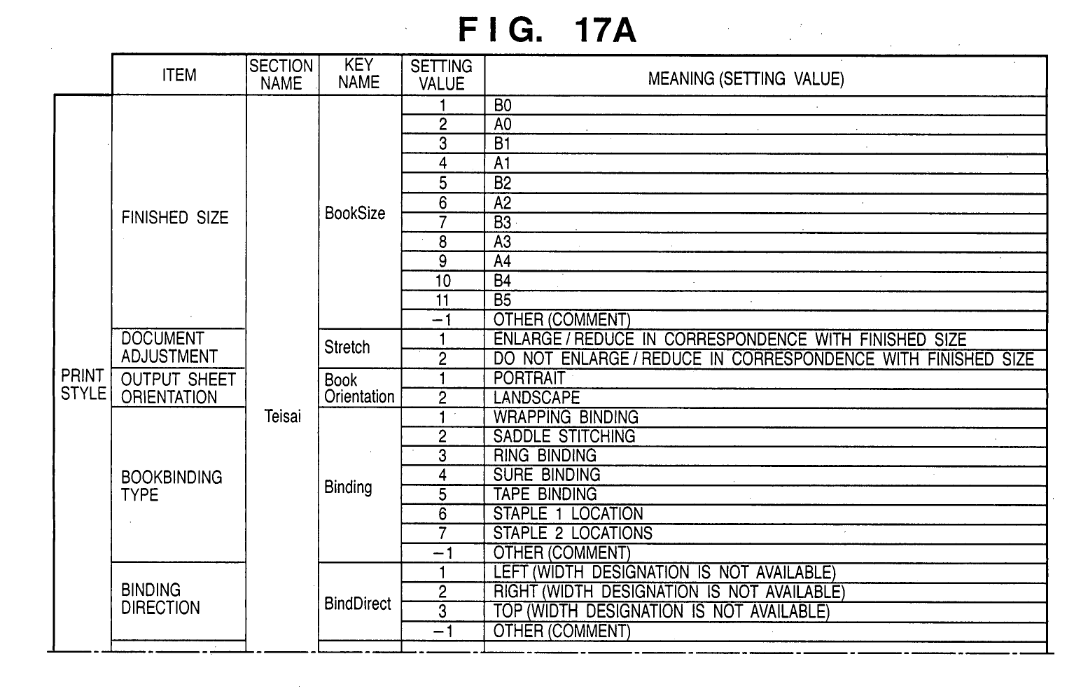

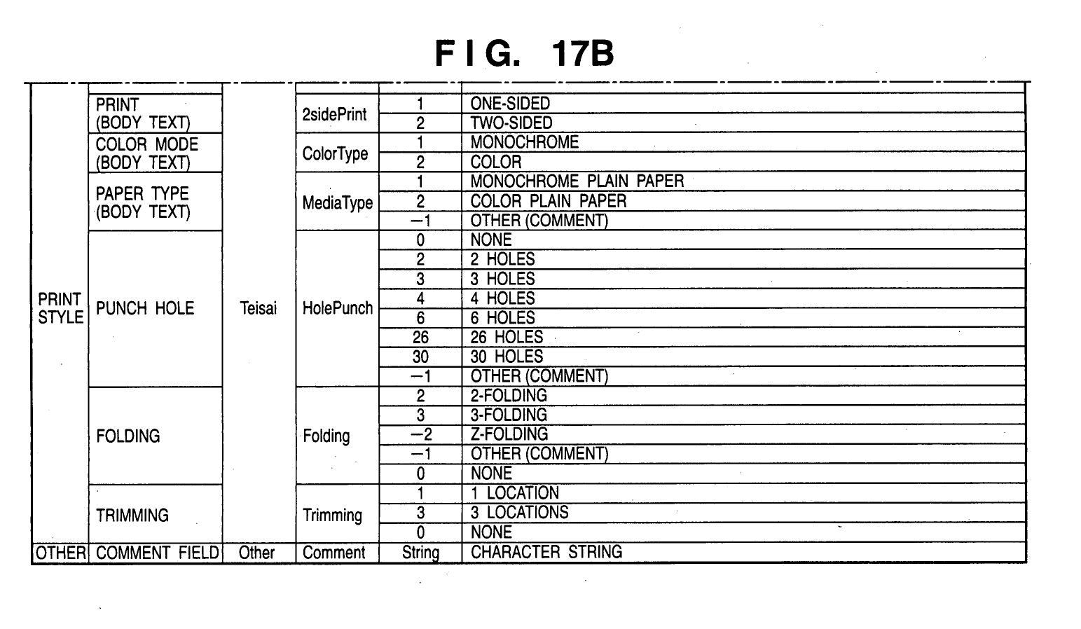

Upon completion of the above settings, the operator of the client PC designates a button image 1006. Upon reception of this designation, the print server 104 specifies key names and setting values corresponding to the contents of the items set using FIGS. 10 to 12 with reference to a table shown in FIGS. 17A and 17B (saved in the auxiliary storage device 203 of the print server 204). For example, when the operator sets “A4” as the finished size, a key name is “BookSize” and a setting value is “9”. In this way, the key names and setting values of all the set items are acquired from the table shown in FIGS. 17A and 17B. Then, a process for setting the acquired setting values in the job ticket 2000 is executed.

That is, a setting value corresponding to the finished size is set in “BookSize” in a “Teisal” section in the job ticket 2000; that corresponding to the set document adjustment in “Stretch”; that corresponding to the set output sheet orientation in “BookOrientation”; that corresponding to the set bookbinding type (e.g., wrapping binding, ring binding, sure binding) in “Binding”; that corresponding to the set binding direction in “BindingDirect”; “that corresponding to the set print face in “2SidePrint”; that corresponding to the set color type in “ColorType”; that corresponding to the set paper type in “MediaType”; that corresponding to the set number of punch holes in “PunchHole”; that corresponding to the set folding in “Folding”; that corresponding to the set trimming in “Trimming”; and that corresponding to the character string input to the field 1004 in “Comment”.

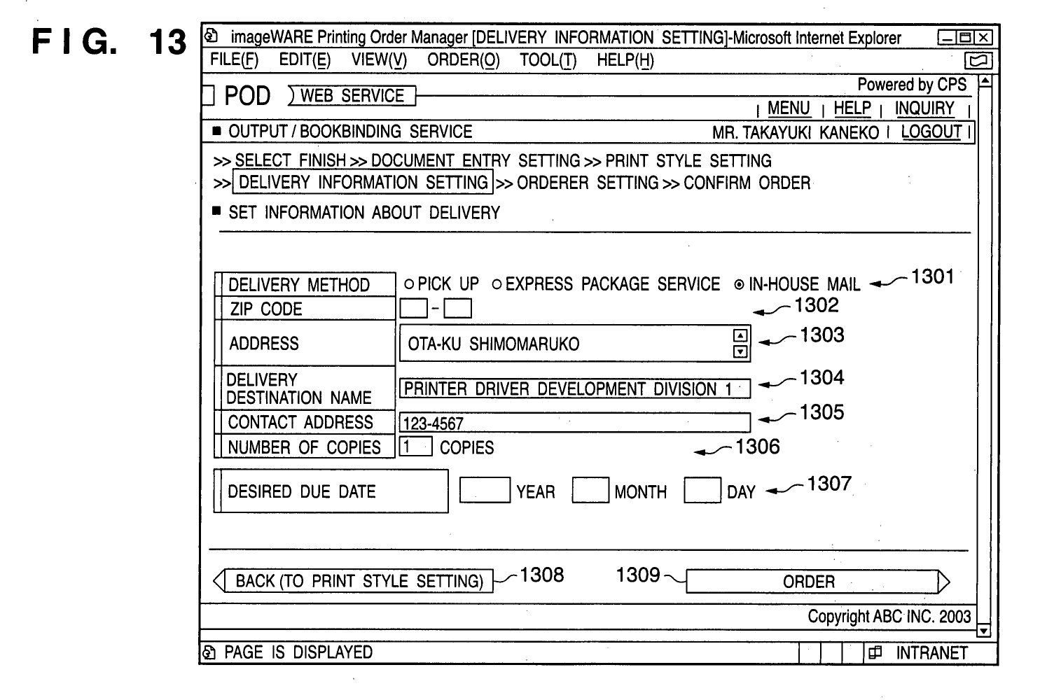

Upon completion of the above process, since the print server 104 transmits data of a home page shown in FIG. 13 to the client PC, the home page shown in, e.g., FIG. 13 is displayed on the display screen of the image display device 204 of the client PC. FIG. 13 shows a display example of the home page that prompts the user of the client PC to set the delivery destination of a print product generated based on the document transmitted in advance.

Referring to FIG. 13, reference numeral 1301 denotes a file which includes radio buttons used to select a delivery method; 1302, a field used to input a zip code of the delivery destination; 1303, a field used to input an address of the delivery destination; 1304, a field used to input a name of the delivery destination; 1305, a field used to input a telephone number of the delivery destination; 1306, a field used to input the number of copies to be delivered; and 1307, a field used to input a delivery date (due date).

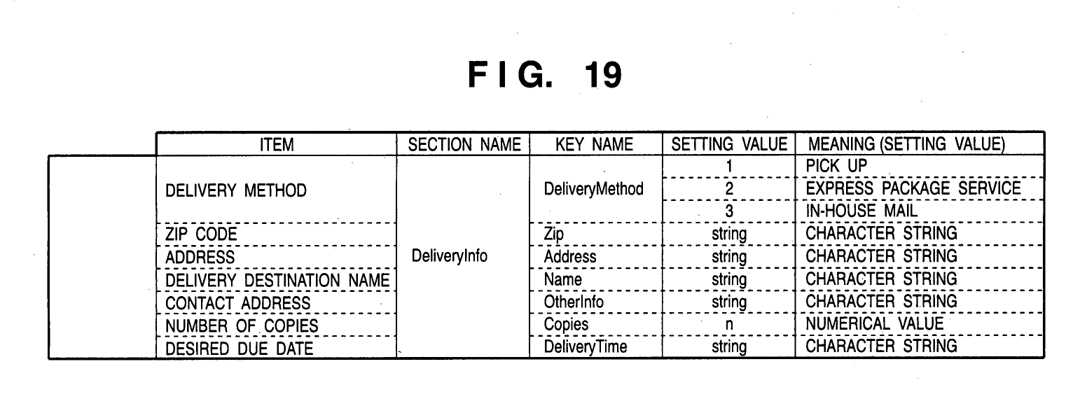

The user of the client PC inputs information to be set in these fields, and designates a button image 1309. Upon reception of this designation, the print server 104 specifies key names and setting values corresponding to the contents of respective items set on FIG. 13 with reference to a table shown in FIG. 19 (saved in the auxiliary storage device 203 of the print server 104). For example, when the user sets “express package service” as the delivery method, a key name is “DeliveryMethod” and a setting value is “3”. In this way, the key names and setting values of all the set items are acquired from the table shown in FIG. 19. Then, a process for setting the acquired setting values in the job ticket 2000 is executed.

That is, a setting value corresponding to the set delivery method is set in “DeliveryMethod” in a “DeliveryInfo” section in the job ticket 2000; that corresponding to the set zip code in “Zip”; that corresponding to the set address in “Address”; that corresponding to the set delivery destination name in “Name”; that corresponding to the set contact address in “OtherInfo”; that corresponding to the set number of copies in “Copies”; and “that corresponding to the set desired delivery date in “DeliveryDay”.

With the above processes, the document entry in S404 and the job ticket generation process in S405 are complete, and a process for saving the generated job ticket as a set together with the document file received in advance in the auxiliary storage device 203 of the print server 104 or that of the database 105 is executed.

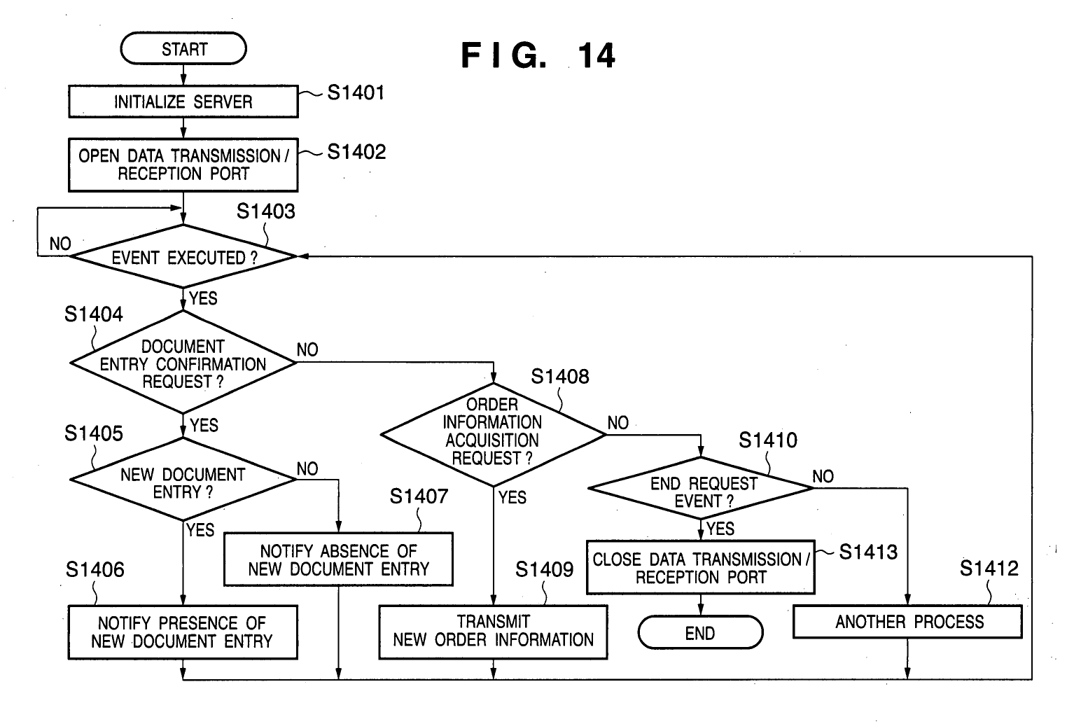

FIG. 14 is a flowchart of the processing implemented when a program, which is held by the auxiliary storage device 203 of the print server 104 to be used in communications with the order manager 402, is loaded onto the RAM 202 of the print server 104, and is executed by the CPU 201 of the print server 104.

When the communication program with the order manager 402 is launched, the CPU 201 of the print server 104 executes an arbitrary initialization process (step S1401). Next, the CPU 201 opens a data transmission/reception communication port used in communications with the order manager 402 (step S1402), and waits for reception of an event (step S1403). With a series of processes executed so far, the print server 104 is ready to exchange data with the order manager 402.

If a document entry confirmation request event is received from the order manager 402 in step S1403, as indicated by S407 (step S1404), the flow advances to step S1405, and the CPU 201 confirms if new order information transmitted from the client PC exists (step S1405). If new order information exists, the CPU 201 sends a message that advises accordingly to the order manager 402 (step S1406), and the flow returns to step S1403 to wait for reception of an event.

If it is determined in step S1405 that no new order information exists, the CPU 201 sends a message that advises accordingly to the order manager 402 (step S1407), and the flow returns to step S1403 to wait for reception of an event.

If the received event is not a document entry confirmation request event in step S1404, the CPU 201 checks if this event is an order information acquisition request event indicated by S408 (step S1408). If the received event is an order information acquisition request event, the flow advances to step S1409. If new order information is available, the CPU 201 transmits it to the order manager 402, as indicated by S409 (step S1409), and the flow returns to step S1403 to wait for reception of an event.

If the received event is not an order information acquisition request event in step S1408, the CPU 201 checks if this event is a server program end request event (step S1410). If the received event is an end request event, the CPU 201 closes the data transmission/reception communication port (step S1413), thus ending this processing.

On the other hand, if the received event is not a server program end request event in step S1410, the CPU 201 executes another process (e.g., virus checking), and the flow returns to step S1403 to wait for reception of an event.

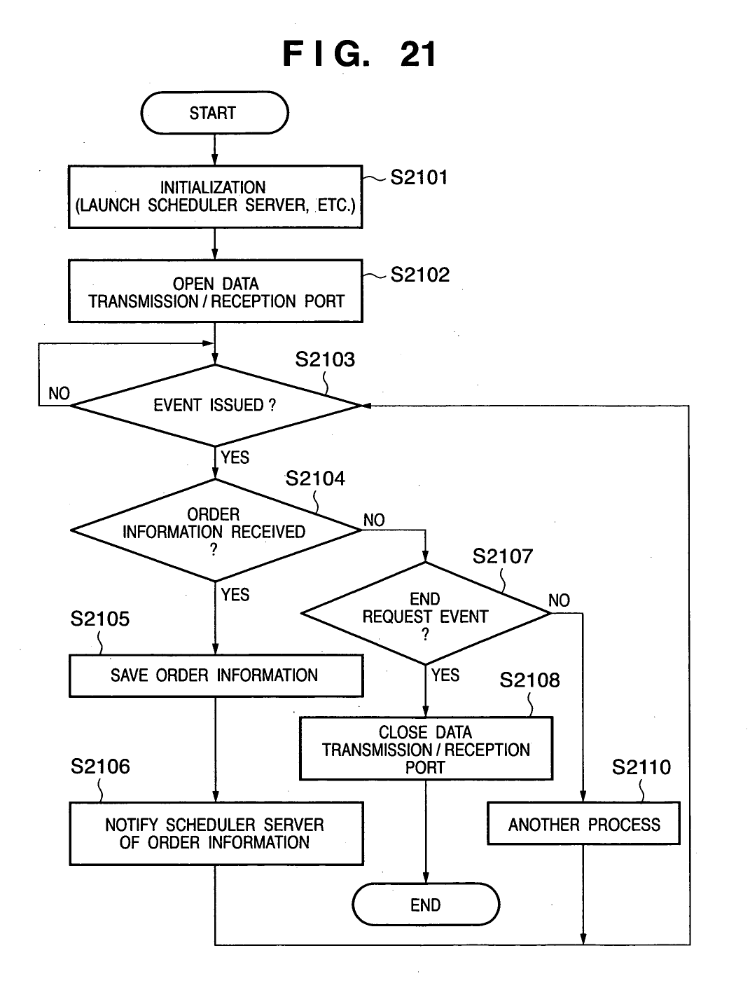

FIG. 21 is a flowchart of the processing implemented when the CPU 201 of the management PC 107 executes the program of the order manager 402.

Upon launching the order manager 402, the CPU 201 of the management PC 107 executes an initialization process (to launch the scheduler server 403 and so forth) (step S2101). The CPU 201 opens a communication port used to exchange data with the print server 104 or scheduler server 403 (step S2102), and waits a process (step S2103). With a series of processes executed so far, the order manager 402 is ready to exchange data with the print server 104 or scheduler server 403.

If the order manager 402 issues some event, the flow advances to step S2104, and the CPU 201 checks if this event is a document entry confirmation request event or order information acquisition request event (step S2104). If this event is a document entry confirmation request event or order information acquisition request event, the flow advances to step S2104.

If this event is an order information acquisition request event, this event is transmitted to the print server 104, which transmits new order information to the order manager 402 of the management PC 107. On the other hand, if this event is a document entry confirmation request event, this event is transmitted to the print server 104, which transmits data indicating whether or not new order information exists to the order manager 402 of the management PC 107.

Therefore, the CPU 201 checks in step S2104 if the order information or the data indicating whether or not new order information exists on the print server 104 side is received from the print server 104. If the order information is received, the flow advances to step S2105, and the received order information is saved in the auxiliary storage device 203 of the management PC 107 (step S2105). Then, the CPU 201 notifies the scheduler server 403 of the order information, as indicated by S410 (step S2106), and the flow returns to step S2103 to wait a process.

On the other hand, if the “data indicating whether or not new order information exists on the print server 104 side” is received from the print server 104, the flow advances to step S2107. On the other hand, if a program end request event is received in step S2103, the flow also advances to step S2107 via step S2104.

The CPU 201 checks in step S2107 if the “data indicating whether or not new order information exists on the print server 104 side” or the end request event is received (step S2107). If the end request event is received, the flow advances to step S2108, and the CPU 201 closes the data transmission/reception communication port opened in step S2102 (step S2108), thus ending this processing.

On the other hand, if it is determined in step S2107 that the “data indicating whether or not new order information exists on the print server 104 side” is received, the flow advances to step S2110, and the CPU 201 executes a process for displaying a message indicated by this data on the display screen of the image display device 204 of the management PC 107 (step S2110). The flow then returns to step S2103 to wait a process.

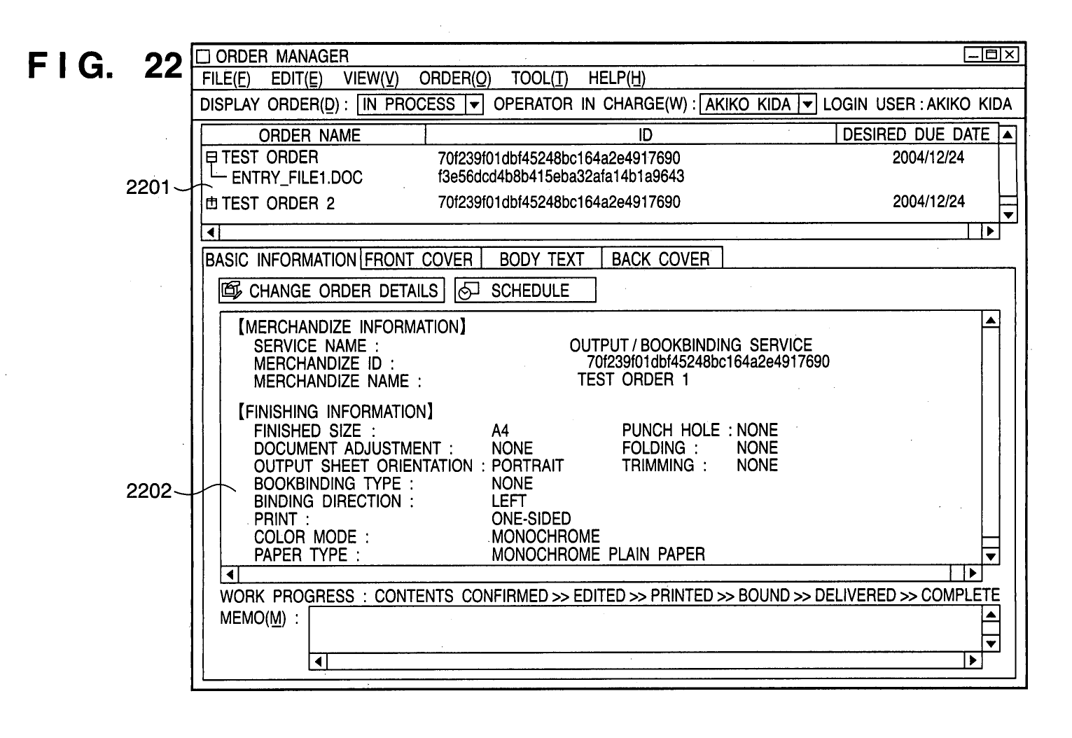

That is, if no end request event is received in step S2107, the flow advances to step S2110 to execute another process, for example, a process for displaying a GUI (graphical user interface) shown in, e.g., FIG. 22 on the display screen of the image display device 204 of the management PC 107.

FIG. 22 shows a display example of the GUI of the order manager 402. Referring to FIG. 22, reference numeral 2201 denotes an area for displaying information (information described in the section 2004) in the “OrderInfo” section in the job ticket 2000. The area 2201 can display the information in the section 2004 of each of one or more job tickets. Reference numeral 2202 denotes an area for displaying information in the selected one of one or more job tickets displayed in the area 2201.

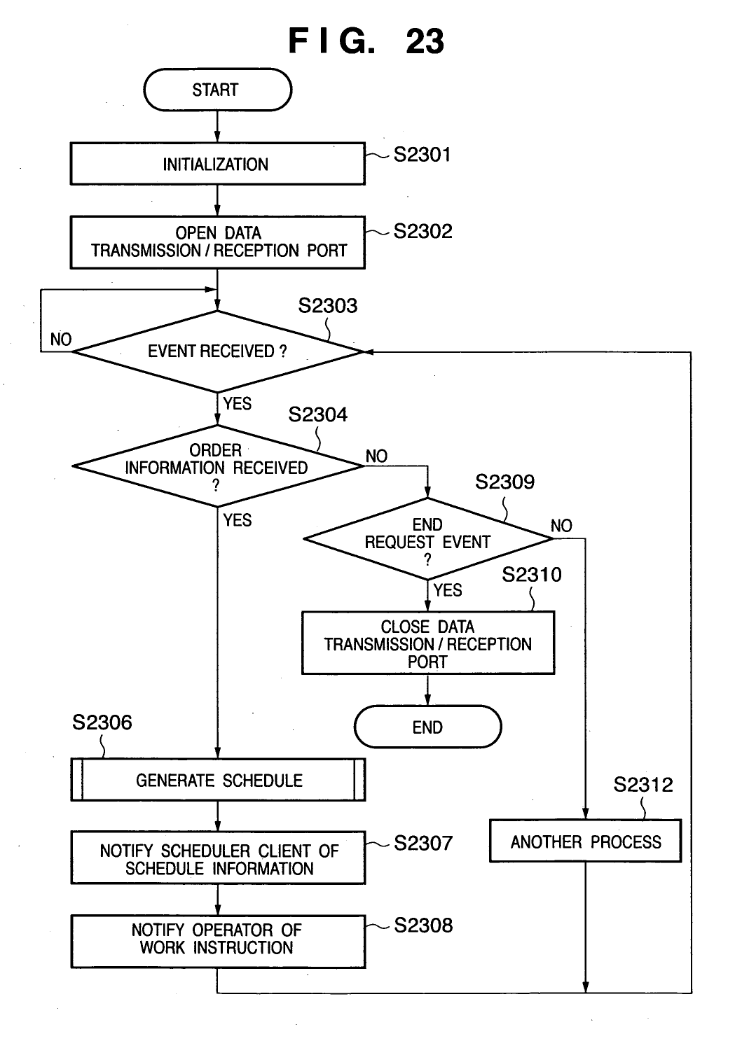

FIG. 23 is a flowchart of the processing when the CPU 201 of the management PC 107 executes the scheduler server 403.

When the scheduler server 403 is launched, the CPU 201 executes an initialization process (step S2301), opens a communication port used in data transmission/reception with the order manager 402 and scheduler client 404 (step S2302), and waits for reception of an event (step S2303). With a series of processes executed so far, the scheduler server 403 is ready to exchange data with the order manager 402 and scheduler client 404.

The CPU 201 determines the type of received data (including an event) (step S2303). If the received data is order information (i.e., order information is received from the order manager 402), the flow advances to step S2306 via step S2304, and the CPU 201 generates schedule information indicating a schedule required to generate a print product in accordance with this order information (step S2306). Details of the process in step S2306 will be described later. That is, in this step, in order to meet the designated due date of a print product to be generated according to this order information, the bookbinding apparatuses and printer to be used are secured, and operators who make this generation operation are secured. As for the due date, since the setting value in [DeliveryDay] in the [DeliveryInfo] section of the job ticket in FIG. 20 is information indicating the due date, the due date can be acquired with reference to this value. Note that the first four digits of this setting value indicate a dominical year, the next two digits indicate a month, and the last two digits indicate a day. Hence, the example of FIG. 20 indicates that the due date is Dec. 24, 2004.

Upon generation of the schedule, the CPU 201 notifies the scheduler client 204 of the generated schedule (step S2307), and notifies the operator PC 108 of a work instruction for the operator via e-mail or the like (step S2308). The flow then returns to step S2303 to wait for reception of an event. Note that the method of notifying the operator of the work instruction in step S2308 is not limited to e-mail, and various other methods such as audible broadcasting, a printed work instruction sheet, and the like may be used.

On the other hand, if it is determined in step S2303 that the received data is an end request event of the scheduler server 403, the flow advances to step S2304. Since the received data is not order information, the flow advances to step S2309. Since the received data is an end request event, the flow then advances to step S2310 to close the data transmission/reception communication port opened in step S2302 (step S2310), thus ending this processing.

If a processing request event other than those described above is received in step S2303, the flow advances to step S2312 via steps S2304 and S2309, and the CPU 201 executes another process (step S2312). The flow then returns to step S2303 to wait for reception of an event. Note that the other process indicates a process executed when a schedule confirmation request or the like is received from the scheduler client 404.

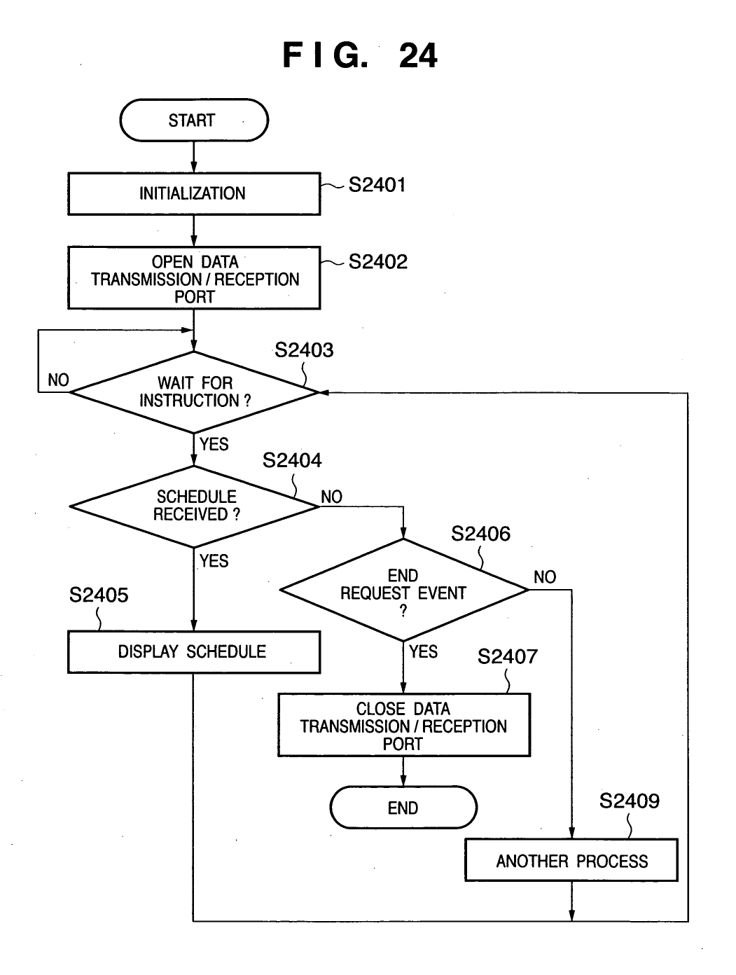

FIG. 24 is a flowchart of the processing implemented when the CPU 201 of the operator PC 108 executes the scheduler client 404.

Upon launching the scheduler client 404, the CPU 201 of the operator PC 108 executes an initialization process (step S2401), opens a communication port used in transmission/reception of data with the scheduler server 403 (step S2402), and waits a process (step S2403). With a series of processes executed so far, the scheduler client 404 is ready to exchange data with the scheduler server 403.

The CPU 201 determines the type of received data (including an event) (step S2403). If the received data is the schedule information notified in step S2307 above (i.e., if the schedule information is received from the scheduler server 403), the flow advances to step S2405 via step S2404, and the CPU 201 displays (or updates display of) the schedule contents on a GUI of the scheduler client 404 (step S2405), and the flow returns to step S2403 to wait a process.

On the other hand, if it is determined in step S2403 that the received data is an end request event of the scheduler client 404, the flow advances to step S2404. Since the received data is not order information, the flow advances to step S2406. Since the received data is an end request event, the flow then advances to step S2407 to close the data transmission/reception communication port opened in step S2402 (step S2407), thus ending this processing.

If a processing request event other than those described above is received in step S2403, the flow advances to step S2409 via steps S2404 and S2406, and the CPU 201 executes another process (step S2409). The flow then returns to step S2403 to wait a process.

Note that the other process indicates a print process of the schedule contents or the like.

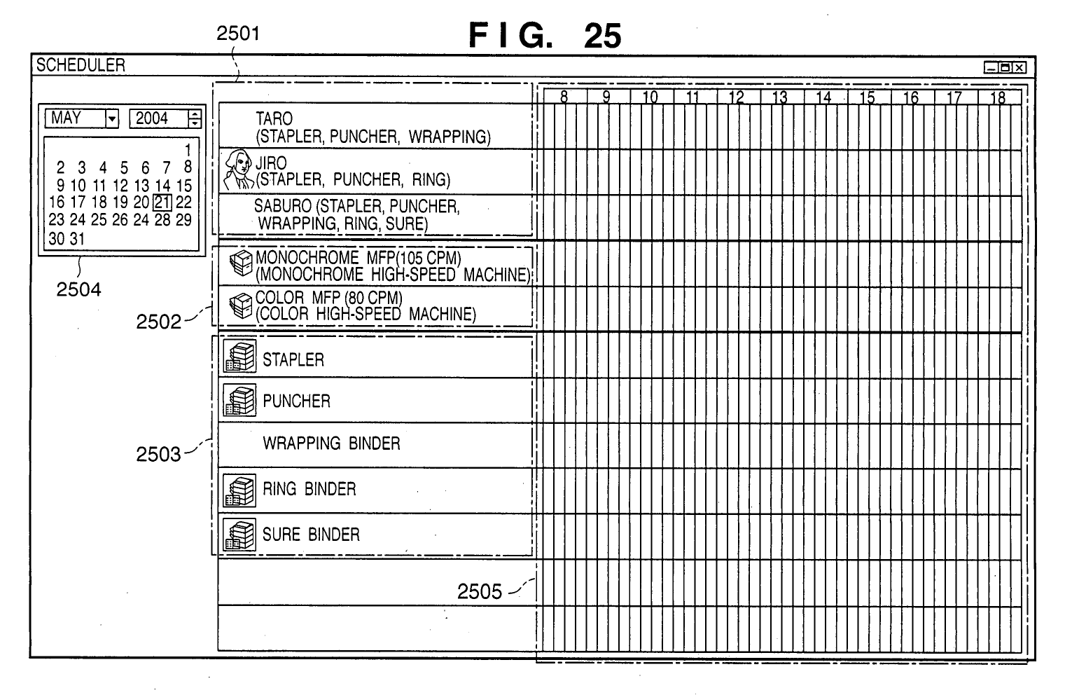

FIG. 25 shows a display example of the GUI of the scheduler client 404 displayed on the display screen of the image display device 204 of the operator PC 108 in step S2405.

Referring to FIG. 25, reference numeral 2501 denotes entries of operators; 2502, entries of the printers 111 and 112; 2503, entries of the bookbinding apparatuses 151 to 153; 2504, an area for displaying a calendar; and 2505, a confirmation area for visually displaying the schedules of the operators, printers, and bookbinding apparatuses. FIG. 25 shows no schedule.

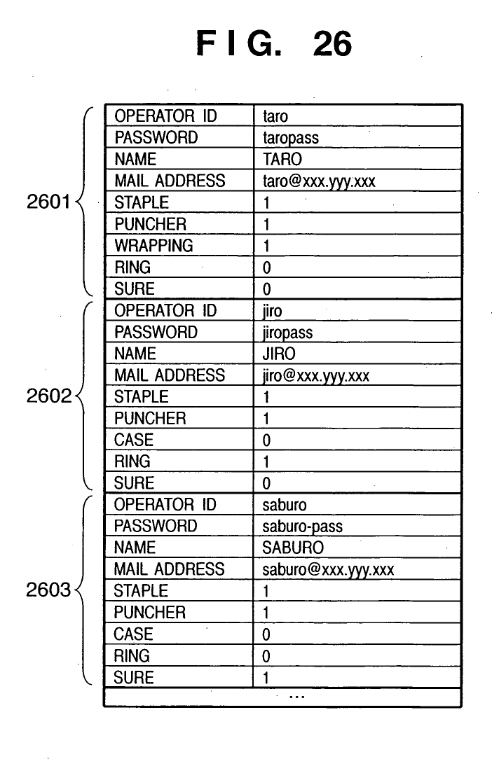

FIG. 26 shows an example of the configuration of a table which registers private information including the abilities of respective operators.

The table shown in FIG. 26 registers private information 2601 of operator “Taro”, private information 2602 of operator “Jiro”, and private information 2603 of operator “Saburo”. As shown in FIG. 26, the private information of each operator includes an ID (operator ID) unique to that operator, a password unique to that operator, an operator name, and a mail address. In addition, the private information includes ability information indicating whether or not that operator has an ability of using respective bookbinding apparatuses (staple, puncher, wrapping, ring, and sure in FIG. 26). For example, as shown in FIG. 26, the ability information of operator “Taro” includes:

| | |
|---|---|
| staple | 1 |
| puncher | 1 |
| wrapping | 1 |
| ring | 0 |
| sure | 0 |

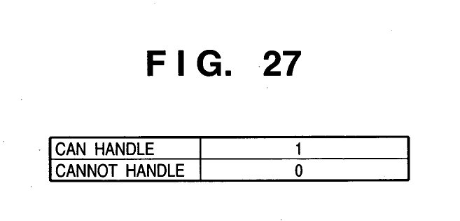

As shown in FIG. 27, “1” indicates that the operator can use the corresponding bookbinding apparatus, and “0” indicates that the operator cannot use it. FIG. 27 shows an example of the configuration of a table indicating the meanings of “1” and “0” above. Hence, operator “Taro” can use the stapler, puncher, and wrapping binder, but cannot use the ring binder and wrapping binder. In this manner, with reference to the ability information of operator “Taro”, the bookbinding apparatuses that can be used by this operator can be specified.

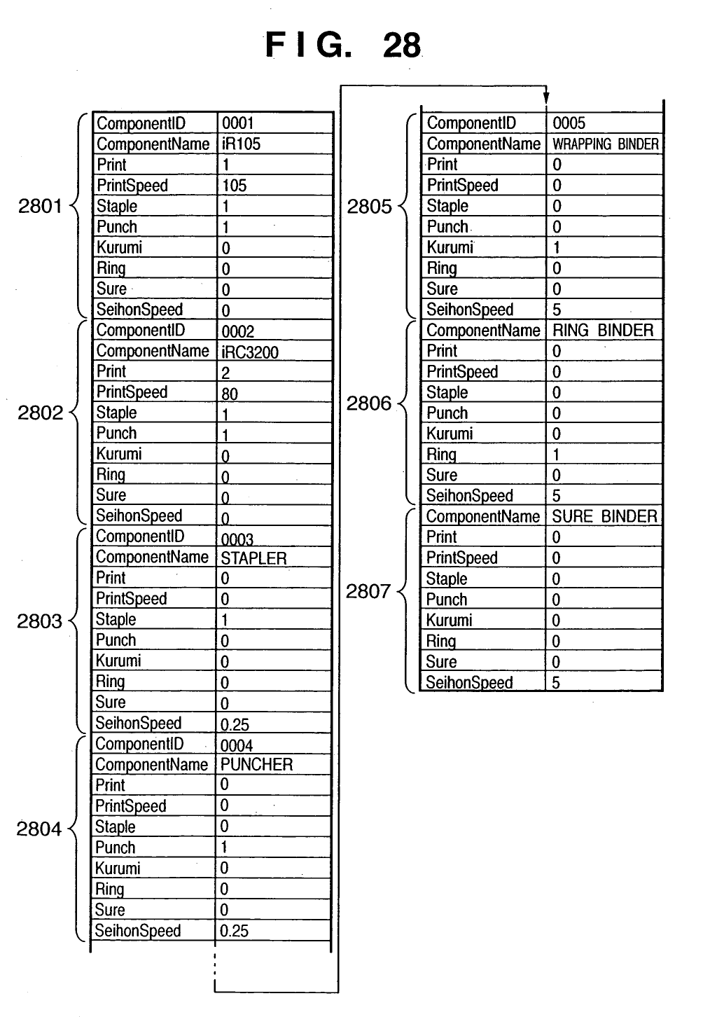

FIG. 28 shows an example of the configuration of a table of information indicating the performances of the printers and bookbinding apparatuses. In FIG. 28, assume that there are two printers, and five bookbinding apparatuses, i.e., the stapler, puncher, wrapping binder, ring binder, and sure binder.

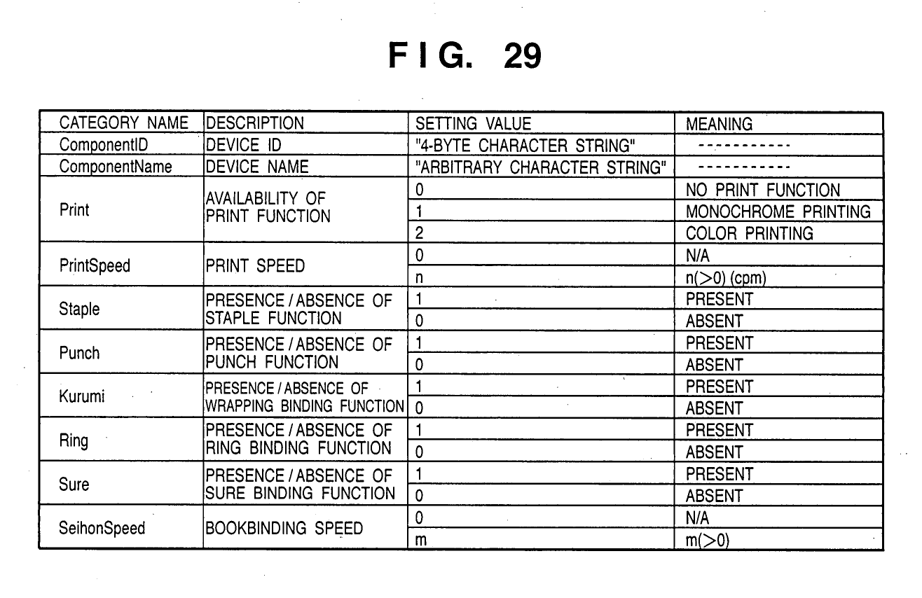

The table shown in FIG. 28 registers performance information 2801 of one printer (e.g., printer 111), performance information 2802 of the other printer (e.g., printer 112), performance information 2803 of the stapler, performance information 2804 of the puncher, performance information 2805 of the wrapping binder, performance information 2806 of the ring binder, and performance information 2807 of the sure binder. The performance information of each device includes the same items. As shown in FIG. 28, the items are ComponentID, ComponentName, Print, PrintSpeed, Staple, Punch, Kurumi, Ring, Sure, and SeihonSpeed. As for settings for respective items, values according to the corresponding items in a table shown in FIG. 29 are adopted. FIG. 29 shows an example of the setting values registered in FIG. 28.

“ComponentID” is an item indicating an ID (device ID) unique to each device, and this ID is assigned in advance to each individual device. “ComponentName” is referred to when the device name is displayed on the GUI. “Print” is an item indicating the presence/absence of a print function. As shown in FIG. 29, if the corresponding value of “Print” is “2”, it indicates “presence of a color print function”; if the value is “1”, it indicates “presence of a monochrome print function”; and if the value is “0”, it indicates “no print function”. For example, “1” is set in item “Print” in the performance information 2801 of the printer, and it indicates that this printer has a monochrome print function. However, “0” is set in item “Print” in the performance information 2804 of the puncher, and it indicates that the puncher has no print function.

“PrintSpeed” is an item indicating the print speed. For example, a value “105” is set in item “PrintSpeed” in the performance information 2801 of the printer, and it indicates that this printer has a print speed that can process 105 pages per minute. However, since the puncher has no print function, as described above, “0” is set in item “PrintSpeed”, and it indicates that the puncher has no interest in information “print speed”.

“Staple” is an item indicating the presence/absence of a staple function. As shown in FIG. 29, if the corresponding value of “Staple” is “1”, it indicates “presence of a staple function”; and if the value is “0”, it indicates “absence of a staple function”. For example, “1” is set in item “Staple” in the performance information 2801 of the printer, and it indicates that this printer has a staple function.

However, “0” is set in item “Staple” in the performance information 2804 of the puncher, and it indicates that the puncher has no staple function.

“Punch” is an item indicating the presence/absence of a punch function. As shown in FIG. 29, if the corresponding value of “Punch” is “1”, it indicates “presence of a punch function”; and if the value is “0”, it indicates “absence of a punch function”. For example, “1” is set in item “Punch” in the performance information 2801 of the printer, and it indicates that this printer has a punch function. However, “0” is set in item “Punch” in the performance information 2803 of the stapler, and it indicates that the stapler has no punch function.

“Kurumi” is an item indicating the presence/absence of a wrapping binding function. As shown in FIG. 29, if the corresponding value of “Kurumi” is “1”, it indicates “presence of a wrapping binding function”; and if the value is “0”, it indicates “absence of a wrapping binding function”. For example, “0” is set in item “Kurumi” in the performance information 2801 of the printer, and it indicates that this printer has no wrapping binding function. However, “1” is set in item “Kurumi” in the performance information 2805 of the wrapping binder, and it indicates that the wrapping binder has a wrapping binding function.

“Ring” is an item indicating the presence/absence of a ring binding function. As shown in FIG. 29, if the corresponding value of “Ring” is “1”, it indicates “presence of a ring binding function”; and if the value is “0”, it indicates “absence of a ring binding function”. For example, “0” is set in item “Ring” in the performance information 2801 of the printer, and it indicates that this printer has no ring binding function. However, “1” is set in item “Ring” in the performance information 2806 of the ring binder, and it indicates that the ring binder has a ring binding function.

“Sure” is an item indicating the presence/absence of a sure binding function. As shown in FIG. 29, if the corresponding value of “Sure” is “1”, it indicates “presence of a sure binding function”; and if the value is “0”, it indicates “absence of a sure binding function”. For example, “0” is set in item “Sure” in the performance information 2801 of the printer, and it indicates that this printer has no sure binding function. However, “1” is set in item “Sure” in the performance information 2807 of the sure binder, and it indicates that the sure binder has a sure binding function.

“SeihonSpeed” is an item indicating the bookbinding speed. For example, a value “0.25” is set in item “SeihonSpeed” in the performance information 2803 of the stapler, and it indicates that this stapler has a bookbinding speed that “processes one copy in 0.25 minutes on average”, as shown in FIG. 29. However, since the printer has no interest in information “bookbinding speed”, “0” is set in item “SeihonSpeed” in the performance information 2801 of the printer.

In this way, the performance information of each individual device includes the same items, and the performance of the device can be acquired with reference to this table.

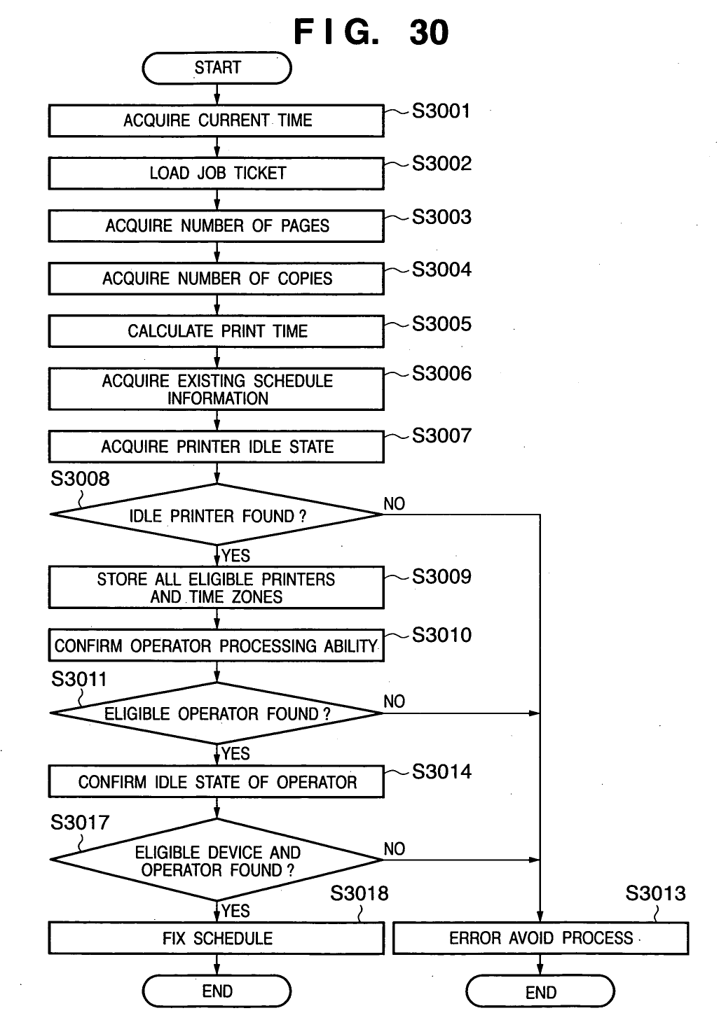

FIG. 30 is a flowchart showing details of the schedule information generation process according to this embodiment. For the sake of simplicity, a case will be described wherein order information that can bind a book by only a simple bookbinding process such as stapling, punching, or the like is received, i.e., a case wherein order information that includes no complicated bookbinding process (wrapping binding, ring binding, sure binding, or the like) is received. More specifically, assume that a value “6” or “7” is registered in item “Binding” in the job ticket of the order information, as shown in FIGS. 17A and 17B.

Upon reception of order information including a job ticket and document data from the order manager 402, as indicated by S410 in FIG. 4, the scheduler server 403 acquires the current time measured by an internal timer of the CPU 201 of the management PC 107 (step S3001), and loads information in the job ticket in a browseable state from the program (step S3002). The scheduler server 403 acquires page information (PageNum) and copy number information (Copies) as information in the job ticket (steps S3003 and S3004), and calculates a time period, which is required for each printer to print the currently received document data (step S3005).

Upon calculating the time period, the scheduler server 403 checks with reference to the setting value of “ColorType” in the job ticket if a color or monochrome print process is required.

Then, with reference to the table data shown in FIG. 28, the scheduler server 403 acquires “PrintSpeed” in the color printer when the color print process is required, or that in the monochrome printer when the monochrome print process is required, and calculates the time period using the acquired “PrintSpeed”, and the number of pages and the number of copies acquired in steps S3003 and S3004 by, for example:
(Processing time period)=(number of pages to be printed)×(number of copies to be printed)/(print speed) [unit: min]

In this embodiment, devices which hold a valid numerical value in “PrintSpeed”, i.e., devices having the print ability are the device with ID=0001 (monochrome MFP 111) and that with ID=0002 (color MFP 112). When the order requests the color print process (the setting value=“2” according to FIGS. 17A and 17B), the time period required for the device with ID=0002 (color MFP 112) to print is calculated using the above equation. On the other hand, when the order requests the monochrome print process (the setting value=“1” according to FIGS. 17A and 17B), the time period required for the device with ID=0001 (monochrome MFP 111) to print is calculated using the above equation.
In case of monochrome MFP 111
   Processing time period=56×100/105=53.3≈53 [min]
In case of color MFP 112
   Processing time period=56×100/80=70 [min]

Next, schedule information indicating a schedule which is determined for each of operators and devices at this time is acquired.

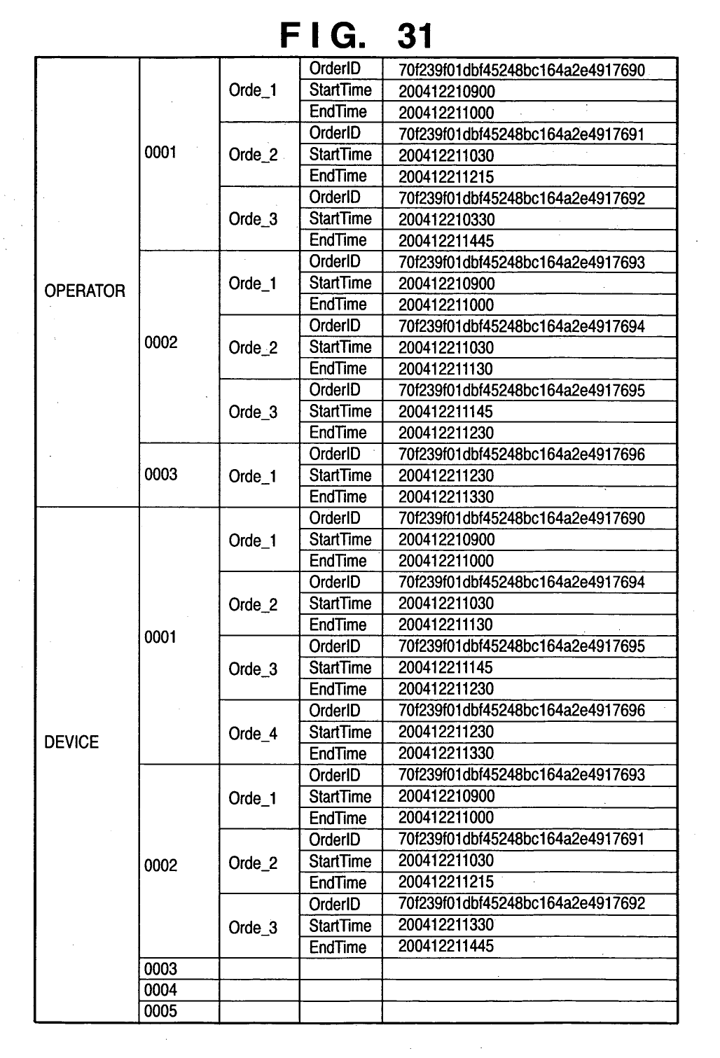

FIG. 31 shows an example of the configuration of a table that registers schedule information of the operators and devices. Data of this table is saved in the auxiliary storage device 203 of the management PC 107. As shown in FIG. 31, this table roughly includes schedule information of the operators, and those of the devices.

The schedule information of each operator will be described below. In FIG. 31, the table registers schedule information of three operators with operator IDs=0001, 0002, and 0003. The already received orders have been allocated to the respective operators. For example, three orders have been allocated to the operator with operator ID=0001. For each order, as shown in FIG. 31, three pieces of information below are managed.
order ID (OrderID)
start time (StartTime)
end time (EndTime)

As described above, the order ID is the setting value of “OrderID” in the “OrderInfo” section registered in the job ticket. The start and end times indicate times when the operator starts and ends the operation for this order, and are set since the process to be described later is executed upon reception of this order. Each of the start and end times is expressed by a 12-digit numerical value, and these digits are handled as year (4 digits), month (2 digits), day (2 digits), hour (2 digits), and minute (2 digits) in turn from the first digit.

Each individual order is assigned a unique identifier like Orde_1, Orde_2, or Orde_3 in FIG. 31.

Hence, with reference to this table, the schedule of the operator with ID=0001 can be acquired as follows. For example, the operator with ID=0001 is busy from “9:00, Dec. 21, 2004” to “10:00, Dec. 21, 2004” since he or she performs an operation for the order “Orde_{—}1”, is busy from “10:30, Dec. 21, 2004” to “12:15, Dec. 21, 2004” since he or she performs an operation for the order “Orde_{—}2”, and is busy from “13:30, Dec. 21, 2004” to “14:45, Dec. 21, 2004” since he or she performs an operation for the order “Orde_{—}3”. The same applies to other operators.

The schedule information of each device will be described below. In FIG. 31, the table registers schedule information of two devices with device IDs=0001 and 0002. Orders have been allocated to the respective devices as in the operators. For example, four orders have been allocated to the device with device ID=0001. The information of each order in the schedule information of each device is the same as that of the operator. The order ID is the setting value of “OrderID” in the “OrderID” section registered in the job ticket, and the start and end times indicate those of use of the device. These values are set since the process to be described later is executed upon reception of the order of interest.

Hence, with reference to this table, the schedule of the device with ID=0002 can be acquired as follows. For example, the device with ID=0002 is busy from “9:00, Dec. 21, 2004” to “10:00, Dec. 21, 2004” since it is used to perform an operation for the order “Orde_{—}1”, is busy from “10:30, Dec. 21, 2004” to “12:15, Dec. 21, 2004” since it is used to perform an operation for the order “Orde_{—}2”, and is busy from “13:30, Dec. 21, 2004” to “14:45, Dec. 21, 2004” since it is used to perform an operation for the order “Orde_{—}3”. The same applies to other devices. The scheduler server 403 can refer to the table shown in FIG. 31 at an arbitrary timing.

Referring back to FIG. 30, the printer which is idle from the current time acquired in step S3001 to the due date is specified with reference to the schedule information table above (step S3007). As the specifying method, for example, work time zones (periods from StartTime to EndTime) are calculated with reference to StartTime and EndTime of a device with the ID of the printer (one of the color and monochrome MFPs determined depending on ColorType) of the respective devices in the table shown in FIG. 31, and it is checked if a time zone (period) other than the work time zones, i.e., an idle time zone is present within a period from the current time acquired in step S3001 to the due date. The ID of the printer which has an idle time zone is temporarily stored in the RAM 202.

It is specified based on the printer ID temporarily stored in the RAM 202 in step S3007, the schedule information table, and the processing time period calculated in step S3005 (step S3008) if the “printer which is idle from the current time acquired in step S3001 to the due date” specified in step S3007 includes a printer which can complete a print process of the currently received document data a predetermined period of time (e.g., one day) before the due date in accordance with the contents described in the job ticket (step S3008).

Details of the process in step S3008 will be described below. In this case, since various processes in step S3008 may be conceivable, a simple example will be described. However, the process in this step is not limited to such specific example.

For example, if the printer specified in step S3007 is a “printer with ID=p”, the work time zones for respective orders are calculated with reference StartTime and EndTime of the respective orders of the device with ID=p in the schedule information table, a time zone other than the work time zones (periods from StartTime to EndTime) of this printer, i.e., an idle time zone, is specified within the time period from the current time acquired in step S3001 to a predetermined period of time before the due date (e.g., one day before the due date), and it is checked for this printer if the duration of the specified idle time zone D is equal to or longer than a print time period T calculated in step S3005. If D>T, the currently received order can be printed within this idle time zone. Hence, in other words, the printer that meets D>T is searched for in step S3008.

Therefore, if the print data which can print the currently received document data before the due date is found in step S3008, the flow advances to step S3009, the ID of this printer is temporarily recorded in the RAM 202, and the times at the two ends of the idle time zones (those at the two ends of the idle time zone D which meets D>T in the above description) found in step S3008, i.e., data indicating the start and end times of the idle time zone are temporarily recorded in the RAM 202 in association with this ID (step S3009).

With the above process, the printer which can print the currently received document from the current time to the due date can be specified. A plurality of printers can be specified at this time.

Next, a process for specifying an operator who has an ability required to receive the current order is executed with reference to the ability information of respective operators of data in the table shown in, e.g., FIG. 26 (step S3010). For example, if the setting value of [HolePunch] is “2” or more with reference to the [Teisai] section in the job ticket in the currently received order information, it is required to form punch holes after the document data in this order information is printed. Hence, an operator who can receive this order is required to have an ability to handle the puncher 152. Therefore, in this case, an operator whose setting value indicating whether or not an operator has an ability to handle a device (bookbinding apparatus) that forms punch holes is a value indicating an “operator has an ability to handle a device (bookbinding apparatus) that forms punch holes” (in case of FIG. 26, the setting value of “Puncher” is “1”) is searched for with reference to the ability information of the operators.

In this way, the operator whose ability information value is “1” for the device designated in the [Teisasi] section in the job ticket is searched for.

If one or more operators are found, i.e., one or more operators who have an ability required to receive the current order are found, the flow advances to step S3014 to specify, with reference to the schedule information table, the printer and operator, included in the operators found in step S3010, who operates an option device (puncher or stapler) of this printer so as to complete a series of processes for finishing a print product by printing the currently received document data according to the contents described in the job ticket and applying a process for, e.g., forming punch holes in the obtained printouts a predetermined period of time (e.g., one day) before the due date (step S3014).

Details of the process in step S3014 will be described below. However, since various processes in this step may be conceivable, a simple example will be described. However, the process in this step is not limited to such specific example.

For example, if each operator specified in step S3010 is an “operator with ID=k”, the work time zones for respective orders are calculated with reference to StartTime and Endtime of the respective orders to be processed by the operator with ID=k, and it is checked if a time other than the work time zones (periods from StartTime and EndTime) of this operator, i.e., an idle time zone is present within a period from the current time acquired in step S3001 to a time a predetermined period time (e.g., one day) before the due date.

If such operator is found, the flow advances to step S3017 to check if the operator and printer which meet:
GS<TS<TN<GN
(where GS is the start time of the idle time zone of the operator, GN is its end time, TS is the start time of the idle time zone of the printer, and TN is its end time) are present (step S3017). That is, a combination of the operator and printer in which the idle time zone of the printer specified in step S3009 is completely included in that of the operator is searched for. The above inequality considers such condition, and a combination of the operator and printer that can receive the current order is searched for using this inequality.

If a plurality of combinations of operators and printers are found or if one operator and a plurality of printers or vice versa are found as a result of search, an operation according to the current order is executed at a time closest to the current time.

When the operator and printer that receive the current order are determined in this manner, the schedule information is updated to register the schedules of the current order in their schedules (step S3018). That is, the start and end times of the idle time zone to be currently used of the printer to be currently used, those of the operator who operates currently, and the order ID of the current order information are registered in the schedule information of the operator and that of the printer, as shown in FIG. 31. Of course, a unique identifier (e.g., Orde_4) is issued for the current order, and is registered, as shown in FIG. 31.

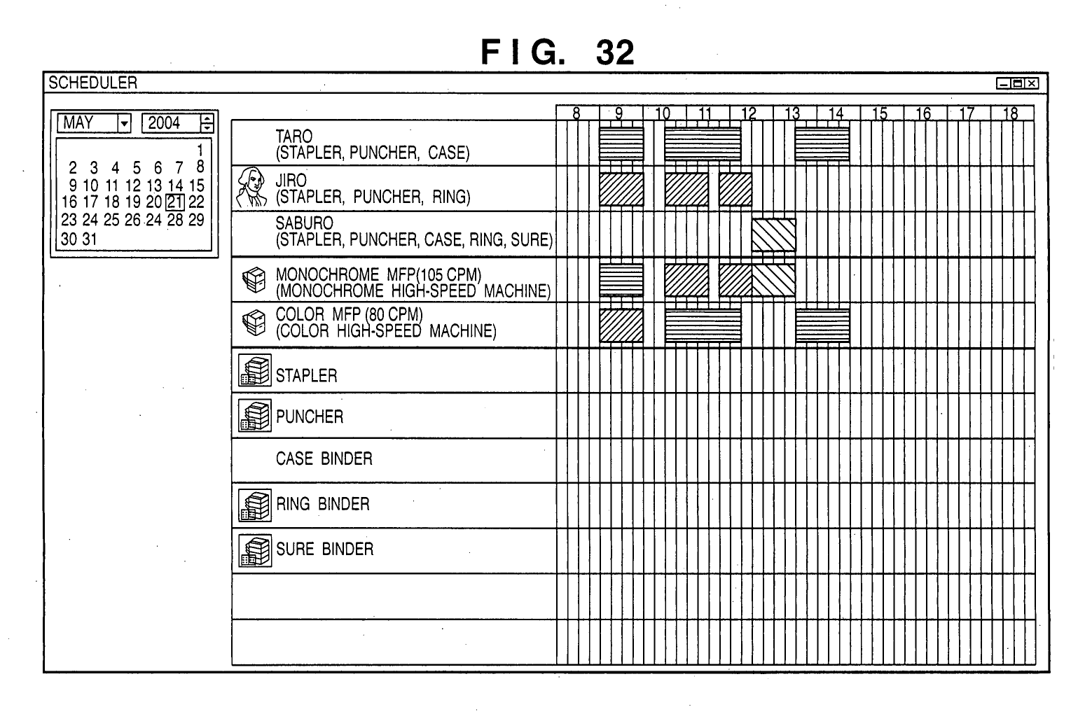

FIG. 32 shows a display example of the GUI that visually displays the schedule information registered in the table shown in FIG. 31. The GUI shown in FIG. 32 further displays time zones indicating work assignment of the operators and devices using rectangles on that shown in FIG. 25.

In this embodiment, upon reception of data of the table shown in FIG. 31 together with data of the table shown in FIG. 26 and data of the table (to be also simply referred to as schedule information hereinafter) shown in FIG. 28 from the scheduler server 403 (step S2404), the scheduler client 404 displays them on the image display device 204 of the operator PC (step S2405).

The scheduler client 404 displays the schedules of the operators and those of the devices on the display screen of the image display device 204 with reference to the schedule information received from the scheduler server 403, as shown in FIG. 32. In this case, the scheduler client 404 displays busy time periods (time periods between StartTime and EndTime) of the operators and devices, i.e., time zones to which works have been assigned, using rectangles, as shown in FIG. 32.

As for this rectangle display, various display modes may be used. For example, different rectangle sizes and colors may be used for respective operators. The same applies to the devices. Also, the method of visually displaying time zones to which works have been assigned on the GUI is not limited to such specific method, and various other methods may be used.

As described above, according to this embodiment, appropriate work schedule assignment can be made by comprehensively judging the abilities and idle states of the operators and those of the devices. In this way, the load on schedule assignment upon reception of an order can be reduced, and consistent schedule management of operators in charge and devices can be made.

When the printer can be directly connected to the Internet, a print job may be directly received via the Internet.

The setting of the due date is not indispensable, and some orders do not require any due date settings. Hence, in such case, the due date need not be set. In this case, upon checking the idle states of the operators and printers, a search process is made while ignoring the due date.

### Second Embodiment

In the first embodiment, as described above, the scheduling method associated with processing of an order which does not include any complicated bookbinding processes (wrapping binding, ring binding, sure binding, and the like) has been explained. However, an actual order input to the system often requires complicated bookbinding processes in addition to staple and punch processes. In such case, the order cannot be processed only by the finishing performance (e.g., staple and punch functions) of the printer, and a print product cannot be obtained unless apparatuses independent from the printer are used. This embodiment has been made in consideration of such situation.

This embodiment is substantially the same as the first embodiment except for the schedule information generation process in step S2306 above.

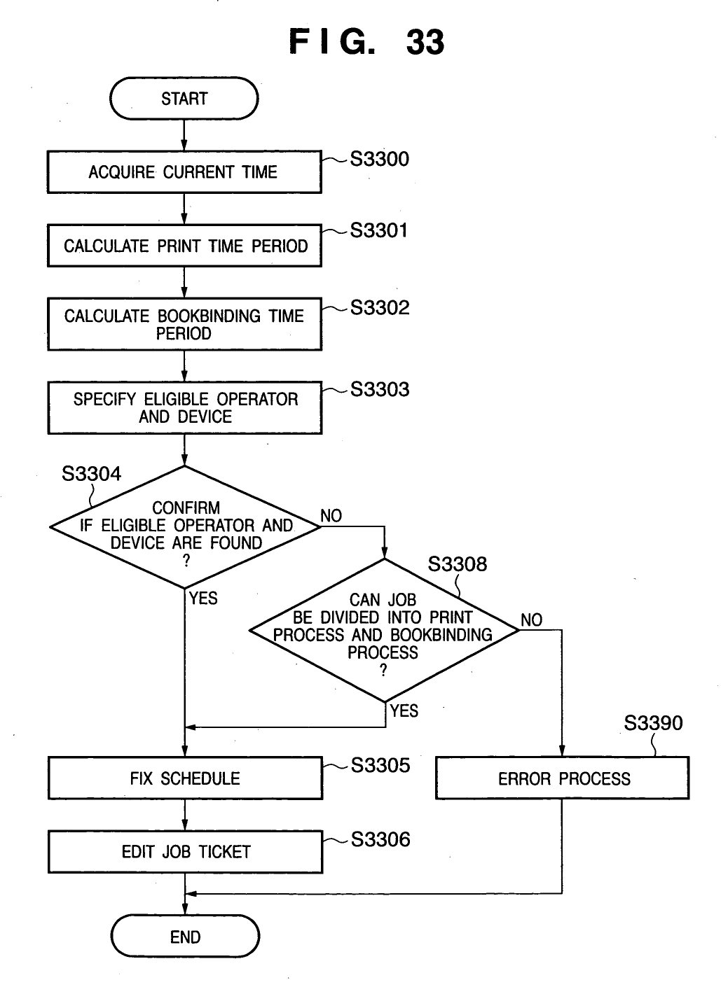

FIG. 33 is a flowchart of the schedule information generation process according to this embodiment, which is executed in step S2306. In this embodiment, since order information which can be bound by executing not only simple bookbinding processes such as a staple setting, punch setting, and the like but also complicated bookbinding processes(wrapping binding, ring binding, sure binding, and the like) is received, values other than “6” and “7” are registered in the item “Binding” in the job ticket of the order information, as shown in FIGS. 17A and 17B.

Upon reception of order information including a job ticket and document data from the order manager 402, as indicated by S410 in FIG. 4, the scheduler server 403 acquires the current time in the same manner as in the first embodiment (in the same manner as in the process in step S3001) (S3300). Then, the scheduler server 403 executes a process for calculating a time period (print time period) required for the printer of interest to print the currently received document data by executing the processes in steps S3002 to S3005 in the same manner as in the first embodiment (step S3301).

The scheduler server 403 acquires copy number information (Copies) as the information in the job ticket, and acquires the bookbinding speeds (SeihonSpeed) (unit: “minutes/copy”) of the respective devices with reference to the table data shown in FIG. 28. Then, the scheduler server 403 calculates time periods (bookbinding processing time periods) required for the bookbinding apparatuses such as the wrapping binder, ring binder, and sure binder to process printouts obtained by printing the currently received document data by the printer (step S3302). For example, the scheduler server 403 calculates a wrapping binding processing time period for the wrapping binder, a ring binding processing time period for the ring binder, and a sure binding processing time period for the sure binder.

The bookbinding processing time period is calculated by:
(Bookbinding processing time period)=(bookbinding speed)×(number of copies) (min)

In the example of the table shown in FIG. 28, the bookbinding speed of each of the stapler and puncher is 0.25 (min/copy), and that of each of the wrapping binder, ring binder, and sure binder is 5 (min/copy). Hence, for example, when the number of copies to be printed is 10, a time period required for the wrapping binder to process the printouts is calculated by:
(Bookbinding processing time period)=5 (min/copy)×10 (copies)=50 (min)
In this way, the durations of the time periods (bookbinding processing time periods) required for the respective devices to execute the bookbinding processes can be calculated.

Hence, a bookbinding apparatus required for the current order is specified from the bookbinding apparatuses (wrapping binder, ring binder, sure binder, and the like) with reference to the setting value of the item “Binding” in the job ticket of the currently received order information, and the bookbinding processing time period is calculated for the specified bookbinding apparatus. For example, when the setting value of the item “Binding” in the job ticket of the order information is “1”, since the wrapping binding process is ordered, the wrapping binder is specified as the bookbinding apparatus required for the current order. Hence, in step S3302 the bookbinding processing time period of the wrapping binder is calculated using the above equation.

Then, processes for respectively specifying the operator and devices (printer, bookbinding apparatus) that can process the currently received order are executed (step S3303).

As for the process for specifying the operator who can receive the currently received order, the process in step S3010 is executed. However, in this embodiment, the operator is required to have an ability to handle bookbinding apparatuses for executing complicated bookbinding processes (wrapping binding, ring binding, sure binding, and the like) For example, when the setting value of the item “Binding” in the job ticket of the order information is “1”, the operator must operate the wrapping binder to execute the wrapping binding process after the document data in this order information is printed. Hence, the operator who can receive this order must have an ability to handle the wrapping binder. Therefore, in such case, in this embodiment, the operator whose setting value indicating whether or not he or she has an ability to handle the wrapping binder (that in the item “wrapping” in the example of FIG. 26) is a value indicating that “he or she has an ability to handle the wrapping binder” (“1” in FIG. 26) is searched for with reference to the ability information of the operators.

On the other hand, the process for specifying the printer that can receive the currently received order is executed in the same manner as in the first embodiment.

As the process for specifying the bookbinding apparatus that can receive the currently received order, the following method is available. In this embodiment, busy time zones of the bookbinding apparatuses are registered in the schedule information as in the operators and printers (as will be described in detail later). For example, when the bookbinding apparatus to be used in the currently received order is the wrapping binder, work time zones for respective orders are calculated with reference to StartTime and EndTime of the respective orders to be processed by the wrapping binder in the schedule information table. A time zone other than the work time zones (periods from StartTime to EndTime) of the wrapping binder, i.e., an idle time zone within a period from the current time acquired in step S3301 to a time a predetermined period of time before (e.g., one day) before the due date is specified. It is then checked if the duration of the specified idle time zone D is equal to or longer than the bookbinding time period T of the wrapping binder calculated in step S3302. If D>T, the currently received order can undergo bookbinding within this idle time zone. In other words, the wrapping binder which meets D>T is searched for in step S3008.

Then, a process for specifying one printer, one bookbinding apparatus, and one operator who operates them of those specified as described above is executed. The specifying method is not particularly limited. For example, let GS be the start time of an idle time zone of the specified operator, GN be its end time, TS be the start time of an idle time zone of the specified printer, TN be its end time, SS be the start time of an idle time zone of the specified bookbinding apparatus, and SN be its end time. Then, it is checked if GS, TS, TN, SS, SN, and GN which meet:
GS<TS<TN<SS<SN<GN
exist (step S3304). That is, a combination of the operator, printer, and bookbinding apparatus in which the idle time zone of the bookbinding apparatus is present after that of the printer, and the idle time zone of the operator completely includes these idle time zones is searched for. The above inequality considers such condition, and a combination of the operator, printer, and bookbinding apparatus that can receive the current order is searched for using this inequality. If a plurality of combinations of operators, printers, and bookbinding apparatus are found as a result of search, an operation according to the current order is executed at a time closest to the current time.

Upon determination of the operator, printer, and bookbinding apparatus that receive the current order in this way, the schedule information is updated to register the schedules of the current order in their schedules (step S3305). That is, the start and end times of the idle time zone to be currently used of the printer to be currently used, those of the operator who operates currently, those of the bookbinding apparatus to be currently used, and the order ID of the current order information are registered in the schedule information of the operator, that of the printer, and that of the bookbinding apparatus, as in the first embodiment.

Also, a process for registering the schedule information of the operator who processes the currently received order is executed (step S3306), thus ending this processing.

On the other hand, GS and GN which meet the above inequality are often not found in the check process in step S3304. Since the operator who has GS and GN that meet the above inequality is required to have an idle time period which is equal to or longer than the total time period of the idle time periods of the printer and bookbinding apparatus, on-duty hours of the operator are prolonged with increasing total time period. Hence, if every operators are busy, those who have an idle time zone that satisfies the above inequality get fewer, and such operator may not exist at all.

If no operator who meets the above inequality exists, i.e., if TS, TN, SS, and SN which meet TS<TN<SS<SN exist but GS and GN which meet GS<TS<TN<SS<SN<GN do not exist, a given operator operates the printer and another operator operates the bookbinding apparatus in place of one operator who operates both the printer and bookbinding apparatus. That is, one order is shared by a plurality of operators.

In this case, the idle time zones of respective operators are referred to first. Let GS1 and GN1 be the start and end times of the idle time zone. Then, GS1, TS, TN, and GN1 which meet GS1<TS<TN<GN1 are searched for. If GS1, TS, TN, and GN1 which meet GS1<TS<TN<GN1 are found, the operator who has an idle time zone defined by the start time GS1 and end time GN1 handles a print process using the printer which has an idle time zone defined by the start time TS and end time TN.

The idle time zones of respective operators are referred to again. Let GS2 and GN2 be the start and end times of the idle time zone. Then, GS2, SS, SN, and GN2 which meet GS2<SS<SN<GN2 are searched for If GS2, SS, SN, and GN2 which meet GS2<SS<SN<GN2 are found, the operator who has an idle time zone defined by the start time GS2 and end time GN2 handles a bookbinding process using the bookbinding apparatus which has an idle time zone defined by the start time SS and end time SN.

Assume that the relation TS<TN<SS<SN is maintained.

Hence, if GS and GN which meet GS<TS<TN<SS<SN<GN are not found in step S3304, the flow advances to step S3308 to search for GS1, TS, TN, and GN1 which meet GS1<TS<TN<GN1 and GS2, SS, SN, and GN2 which meet GS2<SS<SN<GN2 (step S3308).

If GS1, TS, TN, and GN1 which meet GS1<TS<TN<GN1 and GS2, SS, SN, and GN2 which meet GS2<SS<SN<GN2 are found by this search process, the flow advances to step S3305. In this case, schedules are fixed like that the printer which has TS and TN as the two ends of the idle time zone and the operator who has GS1 and GN1 as the two ends of the idle time zone (the operator who operates this printer to execute a print process) are assigned to process the print process of the currently received order, and the bookbinding apparatus which has SS and SN as the two ends of the idle time zone and the operator who has GS2 and GN2 as the two ends of the idle time zone (the operator who operates this bookbinding apparatus to execute a bookbinding process) are assigned to execute the bookbinding process of the currently received order. Hence, the schedule information is updated to register the schedules of the current order in their schedules (step S3305). Then, the process in step S3306 is executed.

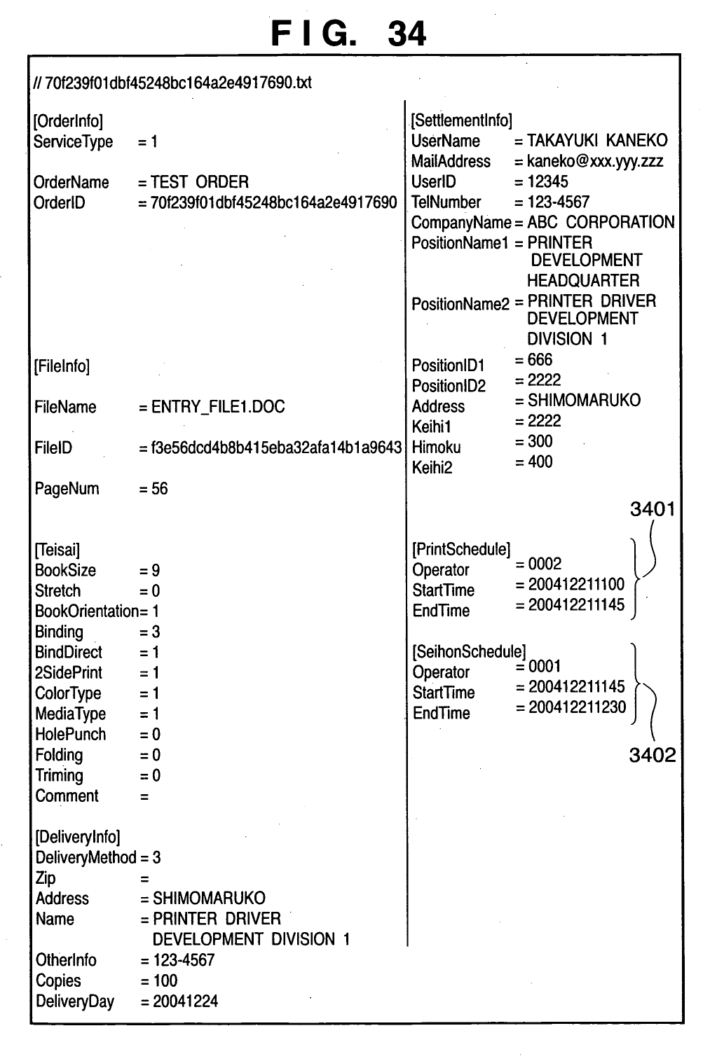

FIG. 34 shows an example of the configuration of the job ticket edited when the flow advances from step S3304 to step S3306 via steps S3308 and S3305.

The job ticket shown in FIG. 34 is registered with schedule information of operators who process an order based on order information which includes the job ticket shown in FIG. 20. Reference numeral 3401 denotes a section which registers the schedule information of an operator who handles the print process; and 3402, a section which registers the schedule information of an operator who handles the bookbinding process.

In each of these sections, the ID of the operator in charge, work start time, and work end time are registered. That is, the section 3401 registers information indicating that the operator with operator ID=0002 executes various works for making the printer print a document received together with the job ticket shown in FIG. 20 from 11:00, Dec. 21, 2004 to 11:45, Dec. 21, 2004. Also, the section 3402 registers information indicating that the operator with operator ID=0001 executes various works for making the bookbinding apparatus bind printouts which have been printed at the time of 11:45, Dec. 21, 2004, from 11:45, Dec. 21, 2004 to 12:30, Dec. 21, 2004.

Note that information to be registered in the job ticket in step S3306 is not limited to this.

The scheduler server 403 notifies the respective operators of their schedule information of the respective processes registered in the job ticket in step S3306 via e-mail. The e-mail addresses of the respective operators can be acquired by searching for those of operators corresponding to the operator IDs registered in the job ticket with reference to the private information table of operators shown in FIG. 26. Hence, the operator can confirm his or her own schedule by receiving and checking this mail message using his or her operator PC 108.

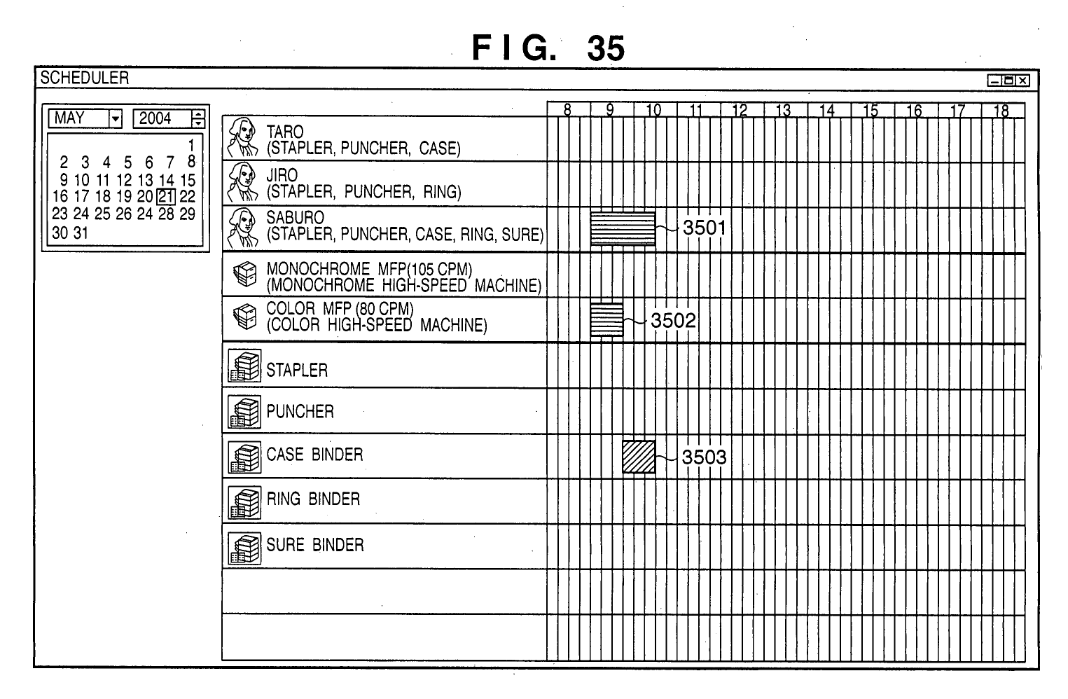

FIGS. 35 to 38 show display examples of the GUI of the scheduler client 404, which is sequentially displayed on the display screen of the image display device 204 of the operator PC 108 in step S2405, when four pieces of schedule information of four orders are sequentially input to the operator PC 108.

For example, the following four pieces of schedule information of four orders are used.

Schedule information 1

The operator (Saburo) works from 9:00 to 10:30

Uses the color MFP 112 from 9:00 to 9:45

Uses the wrapping binder 155 from 9:45 to 10:30

Schedule information 2

The operator (Jiro) works from 9:15 to 10:45

Uses the monochrome MFP 111 from 9:15 to 10:00

Uses the ring binder 153 from 10:00 to 10:45

Schedule information 3

The operator (Taro) makes a print work from 10:00 to 10:45

The operator (Saburo) makes a bookbinding work from 10:45 to 11:30

Uses the color MFP 112 from 10:00 to 10:45

Uses the sure binder 154 from 10:45 to 11:30

Schedule information 4

The operator (Jiro) makes a print work from 11:00 to 11:45

The operator (Taro) makes a bookbinding work from 11:45 to 13:30

Uses the monochrome MFP 111 from 11:00 to 11:45

Uses the wrapping binder 155 from 11:45 to 12:30

If schedule information 1 is input to the operator PC 108, which is not notified of another schedule information yet at that time, a GUI shown in FIG. 35 is displayed on the display screen of the image display device 204 of the operator PC 108.

FIG. 35 shows a display example of the GUI which is displayed on the display screen of the image display device 204 of the operator PC 108, when schedule information 1 is input to the operator PC 108, which is not notified of another schedule information yet at that time. The GUI in FIG. 35 displays a bar 3501 indicating that Saburo works from 9:00 to 10:30, a bar 3502 indicating that he uses the color MFP 112 from 9:00 to 9:45, and a bar 3503 indicating that he uses the wrapping binder 155 from 9:45 to 10:30.

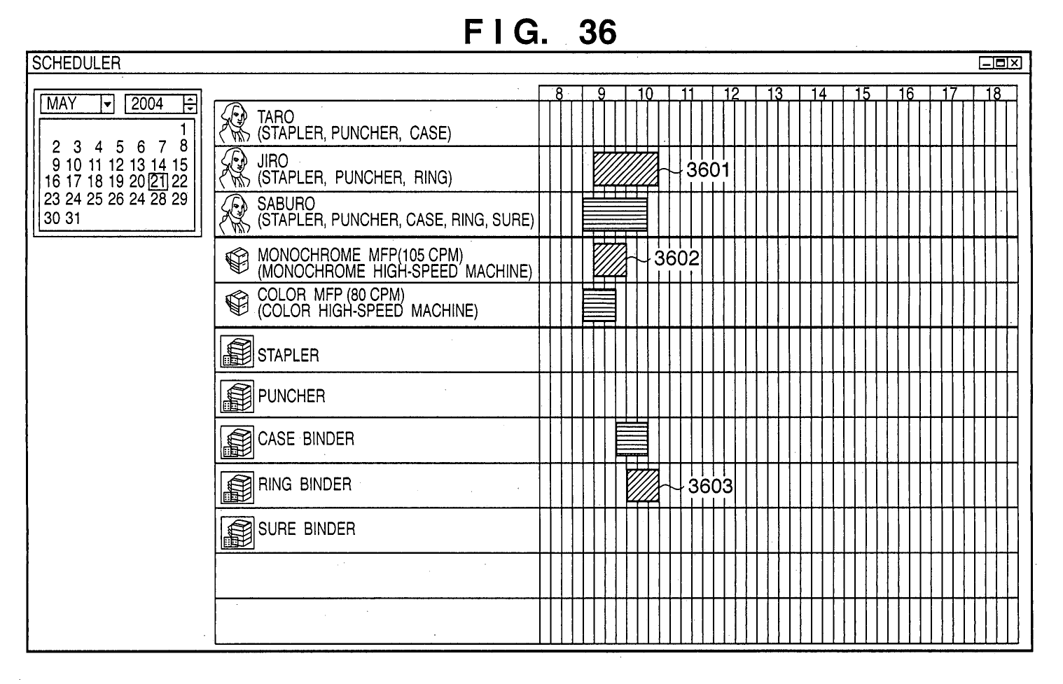

Subsequently, when schedule information 2 is input to the operator PC 108, a GUI shown in FIG. 36 is displayed on the display screen of the image display device 204 of the operator PC 108.

FIG. 36 shows a display example of the GUI which is displayed on the display screen of the image display device 204 of the operator PC 108, when schedule information 2 is input to the operator PC 108, and schedule information 1 has been input in advance. In addition to the display contents shown in FIG. 35, the GUI in FIG. 36 displays a bar 3601 indicating that Jiro works from 9:15 to 10:45, a bar 3602 indicating that he uses the monochrome MFP 111 from 9:15 to 10:00, and a bar 3603 indicating that he uses the ring binder 153 from 10:00 to 10:45.

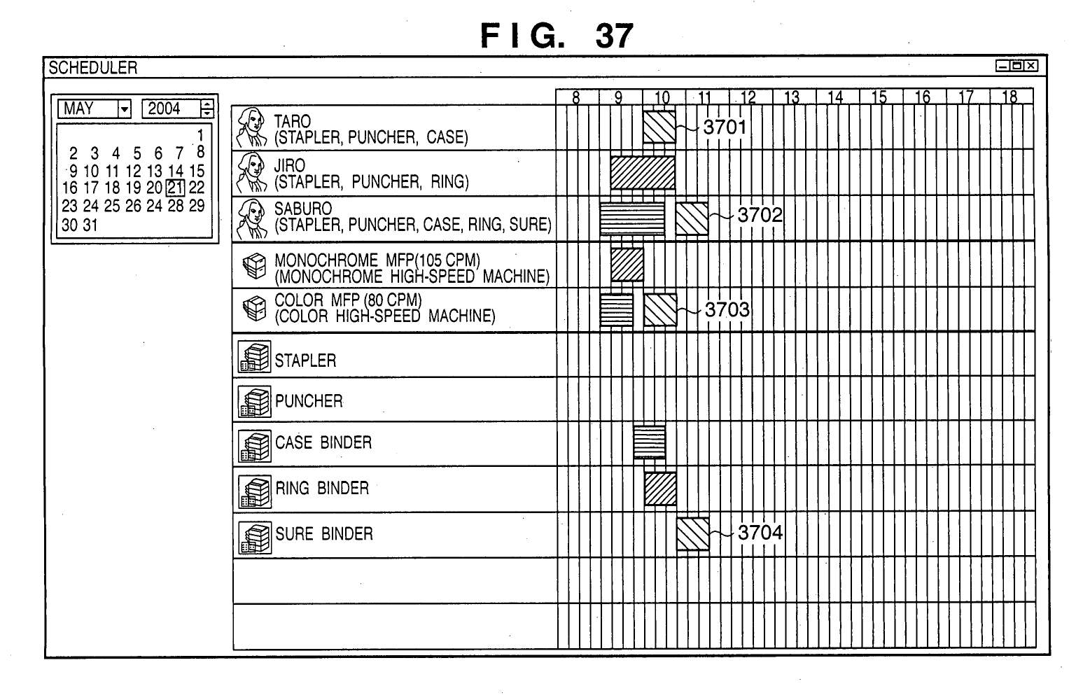

When schedule information 3 is successively input to the operator PC 108, a GUI shown in FIG. 37 is displayed on the display screen of the image display device 204 of the operator PC 108.

FIG. 37 shows a display example of the GUI which is displayed on the display screen of the image display device 204 of the operator PC 108, when schedule information 3 is input to the operator PC 108, and schedule information 1 and schedule information 2 have been input in advance.

In schedule information 3, since the print and bookbinding processes are handled by different operators (since Taro has no ability to operate the sure binder 154, Saburo who has this ability handles operation of the sure binder 154), the schedules of the respective operators, that of the printer, and that of the bookbinding apparatus are managed. In addition to the display contents shown in FIG. 36, the GUI in FIG. 37 displays a bar 3701 indicating that Taro makes a print work from 10:00 to 10:45, a bar 3702 indicating that Saburo makes a bookbinding work from 10:45 to 11:30, a bar 3703 indicating that Taro uses the color MFP 112 from 10:00 to 10:45, and a bar 3704 indicating that Saburo uses the sure binder 154 from 10:45 to 11:30.

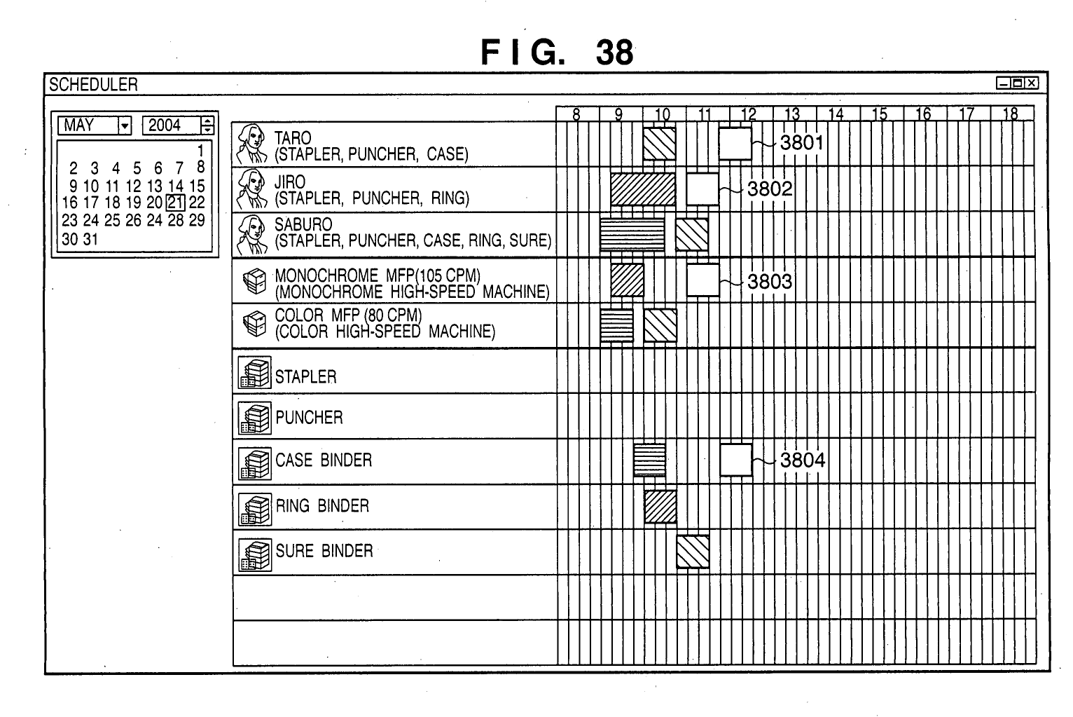

When schedule information 4 is successively input to the operator PC 108, a GUI shown in FIG. 38 is displayed on the display screen of the image display device 204 of the operator PC 108.

FIG. 38 shows a display example of the GUI which is displayed on the display screen of the image display device 204 of the operator PC 108, when schedule information 4 is input to the operator PC 108, and schedule information 1, schedule information 2, and schedule information 3 have been input in advance.

In schedule information 4, since the print and bookbinding processes are handled by different operators (since Jiro has no ability to operate the wrapping binder 155, Taro who has this ability handles operation of the wrapping binder 155), the schedules of the respective operators, that of the printer, and that of the bookbinding apparatus are managed. In addition to the display contents shown in FIG. 37, the GUI in FIG. 38 displays a bar 3801 indicating that Jiro makes a print work from 11:00 to 11:45, a bar 3802 indicating that Taro makes a bookbinding work from 11:45 to 13:30, a bar 3803 indicating that Jiro uses the monochrome MFP 111 from 11:00 to 11:45, and a bar 3804 indicating that Taro uses the wrapping binder 155 from 11:45 to 13:30.

In this manner, scheduling can be flexibly done to share one order by a plurality of operators even when the operators are busy. One order is allocated to a plurality of operators in consideration of the abilities of the respective operators. Hence, upon reception of an order that requires to use various bookbinding apparatuses, such order can be received even when one operator has no ability to handle all bookbinding apparatuses.

### Third Embodiment

Upon reception of a job ticket, the management PC 107 checks with reference to the setting value in the item “Binding” in the job ticket if the bookbinding apparatus such as the wrapping binder 155, ring binder 153, sure binder 154, or the like is required to be used. If the bookbinding apparatus is required (the setting value is other than “6” and “7”), the process in step S2306 may be executed according to the flowchart in FIG. 33; if it is not required (the setting value is either “6” or “7”), the process in step S2306 may be executed according to the flowchart in FIG. 30. That is, the process in step S2306 may be switched to that according to the flowchart in FIG. 30 or that according to the flowchart in FIG. 33 in accordance with the setting value in the item “Binding”.

### Other Embodiments

The objects of the present invention are also achieved when a CPU or MPU of a camera reads out and executes a program code from a recording medium (or storage medium), which records a program code of a software program that can implement the functions of the above-mentioned embodiments. In this case, the program code itself read out from the recording medium implements the functions of the above-mentioned embodiments, and the recording medium which stores the program code constitutes the present invention.

The functions of the above-mentioned embodiments may be implemented not only by executing the readout program code by the camera, but also by some or all of actual processing operations executed by an operating system (OS) running on the camera on the basis of an instruction of the program code.

Furthermore, the functions of the above-mentioned embodiments may be implemented by some or all of actual processing operations executed by a CPU or the like arranged in a function extension card or a function extension unit, which is inserted in or connected to the camera, after the program code read out from the recording medium is written in a memory of the extension card or unit.

When the present invention is applied to the recording medium, that recording medium stores program codes corresponding to the aforementioned flowchart (functional arrangement).

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-250933 filed on Aug. 30, 2004, which is hereby incorporated by reference herein.

What is claimed is:

1. A management system for managing a schedule for one or more printing apparatuses for generating a print product on the basis of a document received from a client terminal, comprising:
first holding means for holding use time band information required to manage use time bands of the one or more printing apparatuses;
second holding means for holding work time band information required to manage work time bands of a plurality of operators who perform works to generate the print product;
printing apparatus specifying means for specifying printing apparatuses each having an idle time period, in which a time period required to assign a print work of the document in a desired quantity can be assured, of the one or more printing apparatuses on the basis of an idle time band of each of the one or more printing apparatuses obtained with reference to the use time band information;
determination means for determining a combination of an operator and a printing apparatus, having an idle time band included in an idle time band of the operator, of the printing apparatuses specified by said printing apparatus specifying means on the basis of the idle time band of each of the plurality of operators obtained with reference to the work time band information; and
notifying means for notifying information associated with the combination determined by said determination means.

2. The system according to claim 1, further comprising:
third holding means for holding second use time band information required to manage use time bands of one or more processing apparatuses for processing prints printed by the printing apparatus; and
processing apparatus specifying means for specifying a processing apparatus having an idle time period, in which a time period required to assign a processing work of prints obtained by printing the document in the desired quantity by the printing apparatus can be assured, of the one or more processing apparatuses on the basis of processing apparatus specifying information used to specify a processing apparatus for processing prints obtained by printing the document by the printing apparatus, and an idle time band of the processing apparatus obtained with reference to the second use time band information, and in that said determination means determines a combination of an operator, printing apparatus, and processing apparatus, which meets a condition that an idle time band of the printing apparatus specified by said printing apparatus specifying means and an idle time band of the processing apparatus specified by said processing apparatus specifying means are included in one idle time band of the operator in this order.

3. The system according to claim 2, further comprising:
when the combination of the operator, printing apparatus, and processing apparatus, which meets the condition, is not found,
first determination means for determining a combination of an operator and printing apparatus, in which an idle time band of the printing apparatus specified by said printing apparatus specifying means is included in an idle time band of the operator; and
second determination means for determining a combination of an operator and processing apparatus, in which an idle time band of the processing apparatus specified by said processing apparatus specifying means is included in an idle time band of the operator,
in that the operator determined by said first determination means is different from the operator determined by said second determination means,
a start time of the idle time band of the processing apparatus included in the idle time band of the operator determined by said second determination means comes after an end time of the idle time band of the printing apparatus included in the idle time band of the operator determined by said first determination means, and
said notifying means notifies information associated with the combination determined by said first determination means, and the combination determined by said second determination means.

4. The system according to claim 1, further comprising due date information reception means for receiving due date information indicating a due date of the print product based on the document from the client terminal, and in that said determination means determines a combination of an operator and printing apparatus in which an idle time band of the printing apparatus specified by said printing apparatus specifying means is included in an idle time band of the operator before the due date indicated by the due date information.

5. The system according to claim 2, further comprising due date information reception means for receiving due date information indicating a due date of the print product based on the document from the client terminal, and
in that said determination means determines a combination of an operator, printing apparatus, and processing apparatus, in which an idle time band of the printing apparatus specified by said printing apparatus specifying means and an idle time band of the processing apparatus specified by said processing apparatus specifying means are included in an idle time band of the operator before the due date indicated by the due date information.

6. The system according to claim 1, further comprising fourth holding means for holding ability information indicating a process which can be handled by each of the plurality of operators who perform works to generate the print product, and
in that said determination means determines a combination of an operator and a printing apparatus, having an idle time band included in an idle time band of the operator, of the printing apparatuses specified by said printing apparatus specifying means on the basis of the process which can be handled by each of the plurality of operators with reference to the ability information.

7. The system according to claim 1, further comprising fifth holding means for holding print speed information indicating print speeds of the one or more printing apparatuses, and
in that said printing apparatus specifying means specifies printing apparatuses each having an idle time period, in which a time period required to assign a print work of the document in the desired quantity at a print speed indicated by the print speed information of each of the one or more printing apparatuses can be assured.

8. The system according to claim 2, wherein the processing apparatus is a bookbinding apparatus for binding prints printed by the printing apparatus, and includes a wrapping binder, ring binder, and sure binder.

9. A management apparatus for managing a schedule required to generate a print product on the basis of a document received from a client terminal, comprising:
first holding means for holding use time band information required to manage use time bands of the one or more printing apparatuses;
second holding means for holding work time band information required to manage work time bands of a plurality of operators who perform works to generate the print product;
printing apparatus specifying means for specifying printing apparatuses each having an idle time period, in which a time period required to assign a print work of the document in a desired quantity can be assured, of the one or more printing apparatuses on the basis of an idle time band of each of the one or more printing apparatuses obtained with reference to the use time band information;
determination means for determining a combination of an operator and a printing apparatus, having an idle time band included in an idle time band of the operator, of the printing apparatuses specified by said printing apparatus specifying means on the basis of the idle time band of each of the plurality of operators obtained with reference to the work time band information; and
notifying means for notifying information associated with the combination determined by said determination means.

10. The apparatus according to claim 9, further comprising:
third holding means for holding second use time band information required to manage use time bands of one or more processing apparatuses for processing prints printed by the printing apparatus; and
processing apparatus specifying means for specifying a processing apparatus having an idle time period, in which a time period required to assign a processing work of prints obtained by printing the document in the desired quantity by the printing apparatus can be assured, of the one or more processing apparatuses on the basis of processing apparatus specifying information used to specify a processing apparatus for processing prints obtained by printing the document by the printing apparatus, and an idle time band of the processing apparatus obtained with reference to the second use time band information, and
in that said determination means determines a combination of an operator, printing apparatus, and processing apparatus, which meets a condition that an idle time band of the printing apparatus specified by said printing apparatus specifying means and an idle time band of the processing apparatus specified by said processing apparatus specifying means are included in one idle time band of the operator in this order.

11. The apparatus according to claim 10, further comprising:
when the combination of the operator, printing apparatus, and processing apparatus, which meets the condition, is not found,
first determination means for determining a combination of an operator and printing apparatus, in which an idle time band of the printing apparatus specified by said printing apparatus specifying means is included in an idle time band of the operator; and
second determination means for determining a combination of an operator and processing apparatus, in which an idle time band of the processing apparatus specified by said processing apparatus specifying means is included in an idle time band of the operator,
in that the operator determined by said first determination means is different from the operator determined by said second determination means,
a start time of the idle time band of the processing apparatus included in the idle time band of the operator determined by said second determination means comes after an end time of the idle time band of the printing apparatus included in the idle time band of the operator determined by said first determination means, and
said notifying means notifies information associated with the combination determined by said first determination means, and the combination determined by said second determination means.

12. The apparatus according to claim 9, further comprising due date information reception means for receiving due date information indicating a due date of the print product based on the document from the client terminal, and in that said determination means determines a combination of an operator and printing apparatus in which an idle time band of the printing apparatus specified by said printing apparatus specifying means is included in an idle time band of the operator before the due date indicated by the due date information.

13. The apparatus according to claim 10, further comprising due date information reception means for receiving due date information indicating a due date of the print product based on the document from the client terminal, and
in that said determination means determines a combination of an operator, printing apparatus, and processing apparatus, in which an idle time band of the printing apparatus specified by said printing apparatus specifying means and an idle time band of the processing apparatus specified by said processing apparatus specifying means are included in an idle time band of the operator before the due date indicated by the due date information.

14. The apparatus according to claim 9, further comprising fourth holding means for holding ability information indicating a process which can be handled by each of the plurality of operators who perform works to generate the print product, and
in that said determination means determines a combination of an operator and a printing apparatus, having an idle time band included in an idle time band of the operator, of the printing apparatuses specified by said printing apparatus specifying means on the basis of the process which can be handled by each of the plurality of operators with reference to the ability information.

15. The apparatus according to claim 9, further comprising fifth holding means for holding print speed information indicating print speeds of the one or more printing apparatuses, and
in that said printing apparatus specifying means specifies printing apparatuses each having an idle time period, in which a time period required to assign a print work of the document in the desired quantity at a print speed indicated by the print speed information of each of the one or more printing apparatuses can be assured.

16. The apparatus according to claim 10, wherein the processing apparatus is a bookbinding apparatus for binding prints printed by the printing apparatus, and includes a wrapping binder, ring binder, and sure binder.

17. A method of controlling a management apparatus for managing a schedule required to generate a print product on the basis of a document received from a client terminal, comprising:
a first holding step of holding use time band information required to manage use time bands of the one or more printing apparatuses;
a second holding step of holding work time band information required to manage work time bands of a plurality of operators who perform works to generate the print product;
a printing apparatus specifying step of specifying printing apparatuses each having an idle time period, in which a time period required to assign a print work of the document in a desired quantity can be assured, of the one or more printing apparatuses on the basis of an idle time band of each of the one or more printing apparatuses obtained with reference to the use time band information;
a determination step of determining a combination of an operator and a printing apparatus, having an idle time band included in an idle time band of the operator, of the printing apparatuses specified in said printing apparatus specifying step on the basis of the idle time band of each of the plurality of operators obtained with reference to the work time band information; and
notifying step of notifying information associated with the combination determined in the determination step.

18. A program making a computer execute a control method of a management apparatus of claim 17.

19. A computer-readable storage means storing a program of claim 18.
